(19) United States
(12) Patent Application Publication
(10) Pub. No.: US 2026/0006372 A1
(43) Pub. Date: Jan. 1, 2026

(54) HEADPHONES

(71) Applicant: SHENZHEN SHOKZ CO., LTD., Shenzhen (CN)

(72) Inventors: Yueqiang WANG, Shenzhen (CN); Junjiang FU, Shenzhen (CN); Song YOU, Shenzhen (CN); Yingying ZHANG, Shenzhen (CN)

(73) Assignee: SHENZHEN SHOKZ CO., LTD., Shenzhen (CN)

(21) Appl. No.: 19/322,750

(22) Filed: Sep. 9, 2025

Related U.S. Application Data
(63) Continuation of application No. PCT/CN2024/076066, filed on Feb. 5, 2024.

(51) Int. Cl. H04R 1/10; H04R 1/06; H04R 9/06

(52) U.S. Cl. CPC H04R 1/1075; H04R 1/06; H04R 1/1008; H04R 1/105; H04R 9/06; H04R 2400/11; H04R 2460/13

(57) ABSTRACT

The present disclosure discloses a headphone, and the headphone comprises a speaker assembly and a wearing assembly. The speaker assembly includes a bone conduction speaker. The bone conduction speaker includes a core housing, a first vibration transmitting plate, a transducer, a vibration plate, and a lead wire. The first vibration transmitting plate includes an inner ring fixing portion, an outer ring fixing portion, and at least two elastic connecting portions. The at least two elastic connecting portions are connected between the inner ring fixing portion and the outer ring fixing portion, the inner ring fixing portion is connected to the transducer, the outer ring fixing portion is connected to the core housing, so that the transducer is suspended in the core housing, and the vibration plate is connected to the transducer. The lead wire is connected to the transducer and includes a first lead portion extending from the inner ring fixing portion to the outer ring fixing portion. A dimension of the first vibration transmitting plate along a long axis direction is larger than a dimension of the first vibration transmitting plate along a short axis direction, and an angle between the first lead portion and the long axis direction is less than an angle between the first lead portion and the short axis direction. In this way, the structural stability of the speaker assembly can be enhanced.

### CROSS-REFERENCE TO RELATED APPLICATIONS

The present application is a continuation of International Application No. PCT/CN2024/076066, filed on Feb. 5, 2024, the entire contents of which are incorporated herein by reference.

### TECHNICAL FIELD

The present disclosure relates to the technical field of electronic devices, and in particular, to headphones.

### BACKGROUND

With the continuous popularity of electronic devices, electronic devices have become indispensable tools for social interaction and entertainment in daily life, and users are placing increasingly higher demands on such devices. Electronic devices (e.g., headphones, smart glasses, etc.) have also been widely applied in daily life and can be used in cooperation with terminal devices (e.g., mobile phones, computers) to provide an auditory experience for users.

However, in existing headphones, the structure of bone conduction speakers is unstable during vibration.

### SUMMARY

The present disclosure provides a headphone, and the headphone comprises a speaker assembly and a wearing assembly connected to the speaker assembly. The wearing assembly is configured to position the speaker assembly at a facial area on a front side of a tragus of a user in a wearing state. The speaker assembly includes a bone conduction speaker. The bone conduction speaker includes a core housing, a first vibration transmitting plate, a transducer, a vibration plate, and a lead wire. The first vibration transmitting plate includes an inner ring fixing portion, an outer ring fixing portion, and at least two elastic connecting portions. The outer ring fixing portion is disposed around a periphery of the inner ring fixing portion. The at least two elastic connecting portions are connected between the inner ring fixing portion and the outer ring fixing portion. The inner ring fixing portion is connected to the transducer. The outer ring fixing portion is connected to the core housing. The transducer is suspended in the core housing. The vibration plate is connected to the transducer. The lead wire is connected to the transducer. The lead wire includes a first lead portion extending from the inner ring fixing portion to the outer ring fixing portion. When viewed along a vibration direction of the vibration plate, the first vibration transmitting plate has a long axis direction and a short axis direction that are perpendicular to each other. A dimension of the first vibration transmitting plate along the long axis direction is larger than a dimension of the first vibration transmitting plate along the short axis direction. An angle between the first lead portion and the long axis direction is less than an angle between the first lead portion and the short axis direction.

In some implementations, the first lead portion is arranged along the long axis direction.

In some embodiments, the core housing is provided with rotating shaft mechanisms spaced apart from each other along the short axis direction. The rotating shaft mechanisms are configured to define a rotation axis for the core housing to rotate around. The lead wire includes a second lead portion, and the second lead portion is connected to an end of the first lead portion close to the outer ring fixing portion and extends toward the rotating shaft mechanisms along a circumferential direction of the core housing.

In some embodiments, a lead slot is arranged on the core housing along the circumferential direction of the core housing, and the second lead portion is embedded in the lead slot.

In some embodiments, a first hollow area is arranged on the outer ring fixing portion. A first embedded block is arranged on the core housing. The first embedded block is further embedded in the first hollow arca, the lead slot further extends to the first embedded block. The first vibration transmitting plate is a metal member, and the first embedded block is a plastic member.

In some embodiments, a housing lead hole is arranged on the core housing, an extension direction of the housing lead hole intersects with the rotation axis, and the second lead portion further passes through the housing lead hole and is configured to connect a control circuit board.

In some embodiments, the speaker assembly further includes a main housing. The core housing includes a bottom wall and a peripheral wall connected to the bottom wall to form an accommodation space with an opening at one end. The transducer is arranged in the accommodation space. The housing lead hole is arranged on the bottom wall. The rotating shaft mechanisms are arranged on the peripheral wall. The rotating shaft mechanisms rotationally support the core housing on the main housing. The control circuit board is arranged in the main housing and is located on a side of the bottom wall of the core housing away from the transducer.

In some embodiments, the transducer includes a bracket and a coil arranged on the bracket. A weight reduction chamber is arranged on the bracket. The bracket is connected to the inner ring fixing portion. A first bracket lead hole is arranged on the bracket. The first bracket lead hole is connected to the weight reduction chamber and a side of the bracket close to the inner ring fixing portion. The lead wire includes a third lead portion. The third lead portion is connected to an end of the first lead portion close to the inner ring fixing portion. The third lead portion extends along the first bracket lead hole to the weight reduction chamber and is electrically connected to the coil.

In some embodiments, a second hollow area is arranged on the inner ring fixing portion. A second embedded block is arranged on the bracket. At least a part of the second embedded block is embedded in the second hollow area. The first bracket lead hole is arranged on the second embedded block. The first vibration transmitting plate is a metal member, and the second embedded block is a plastic member.

In some embodiments, the transducer includes a magnetic conductive cover, a coil, and a bracket. The magnetic conductive cover is configured in a cylindrical shape and is provided with connecting holes connecting an inner wall surface and an outer wall surface of the magnetic conductive cover along a radial direction of the magnetic conductive cover. The bracket is arranged on the magnetic conductive cover in molded manner and includes a bracket body, a limiting portion, and a connecting portion. At least a part of the bracket body is arranged inside the inner wall surface. The limiting portion is arranged on the outer wall surface. The connecting portion integrally connects the bracket body and the limiting portion through the connecting holes. The limiting portion is configured to limit the coil arranged on the outer wall surface. The bracket body is connected to the vibration plate.

In some embodiments, the limiting portion abuts against the coil along an axial direction of the magnetic conductive cover.

In some embodiments, the limiting portion is arranged in a ring shape along a circumferential direction of the magnetic conductive cover.

In some embodiments, the limiting portion includes a first sub-limiting portion and a second sub-limiting portion spaced apart along the axial direction of the magnetic conductive cover, and the coil is wound between the first sub-limiting portion and the second sub-limiting portion.

In some embodiments, a material density of the bracket is less than a material density of the magnetic conductive cover.

In some embodiments, a weight reduction chamber is arranged on the bracket body. A bracket lead hole is arranged on the connecting portion. A lead end of the coil further extends into the weight reduction chamber through the bracket lead hole, and the lead wire is connected to the lead end of the coil in the weight reduction chamber.

In some embodiments, the lead wire includes two groups of wires, the lead end includes two groups of ends, the two groups of wires connect to the two groups of ends at two connection locations, respectively. The bracket body is provided with a spacing mechanism disposed in the weight reduction chamber, and the spacing mechanism is configured to make the two connection locations maintain a predetermined interval.

In some embodiments, the bracket body is provided with a first socket hole and a plurality of first plug posts on a side of the bracket body facing the inner ring fixing portion. The plurality of first plug posts are arranged around and spaced apart on a periphery of the first socket hole. The inner ring fixing portion is provided with an exposed hole and a plurality of assembly holes. The plurality of assembly holes are arranged around and spaced apart on a periphery of the exposed hole. The first socket hole is exposed through the exposed hole. A first plug post of the plurality of first plug posts is inserted into a corresponding assembly hole of the plurality of assembly holes. The vibration plate is provided with a second plug post and a plurality of second socket holes. The plurality of second socket holes are arranged around and spaced apart on a periphery of the second plug post. The second plug post is plug-fitted with the first socket hole. The plurality of first plug posts are plug-fitted with the plurality of second socket holes.

In some embodiments, the bracket body is further provided with a third plug post located in the first socket hole. The vibration plate is provided with a third socket hole located on the second plug post, and the third plug post is plug-fitted with the third socket hole.

In some embodiments, the bone conduction speaker further includes a cover. The transducer includes a bracket. The first vibration transmitting plate is connected to the bracket and the core housing to suspend the transducer in the core housing. The vibration plate is connected to the bracket. The bracket is provided with a first weight reduction chamber located inside the core housing and having an open end, and the cover is configured to cover the open end of the first weight reduction chamber.

In some embodiments, the core housing includes a bottom wall and a peripheral wall connected to the bottom wall to form an accommodation space with an opening at one end. The transducer is arranged in the accommodation space, and the open end of the first weight reduction chamber is arranged toward the bottom wall.

In some embodiments, the cover seals the first weight reduction chamber on a side of the open end of the first weight reduction chamber.

In some embodiments, the cover is provided with a second weight reduction chamber on a side of the cover facing the first weight reduction chamber, and the first weight reduction chamber and the second weight reduction chamber are connected to each other.

In some embodiments, the cover is detachably connected to the bracket.

In some embodiments, the bracket is arranged with a socket hole located at a periphery of the first weight reduction chamber. The cover includes a cover body and a plug post disposed on a side of the cover body. The plug post is plugged with the socket hole, and the cover body covers the open end of the first weight reduction chamber.

In some embodiments, the bone conduction speaker further includes a vibration transmitting face-attaching assembly. The core housing includes a bottom wall and a peripheral wall connected to the bottom wall to form an accommodation space with an opening at one end. The transducer is placed in the accommodation space through an open end of the core housing. The transducer includes a bracket. The first vibration transmitting plate is connected to the bracket and the core housing to elastically suspend the transducer in the core housing. The vibration transmitting face-attaching assembly is assembled and fixed on the bracket along a spacing direction between the bracket and the bottom wall. The bottom wall is provided with through holes opposite to the bracket. The through holes are configured to allow a support fixture to be inserted into the accommodation space and support the bracket through the through holes when the vibration transmitting face-attaching assembly is assembled and fixed on the bracket.

In some embodiments, when viewed along the vibration direction of the transducer, the bone conduction speaker has a long axis direction and a short axis direction. A dimension of the bone conduction speaker along the long axis direction is larger than a dimension of the bone conduction speaker along the short axis direction. A count of the through holes is two, and the two through holes are spaced apart along the long axis direction.

In some embodiments, in a reference plane perpendicular to the vibration direction of the transducer, the through holes form a first projection region in the reference plane along the vibration direction. The bracket forms a second projection region in the reference plane along the vibration direction. A ratio of an area of an overlap region of the first projection region and the second projection region to an arca of the second projection region is greater than or equal to 0.3.

In some embodiments, the first vibration transmitting plate includes an inner ring fixing portion, an outer ring fixing portion, and at least two elastic connecting portions. The outer ring fixing portion is disposed around a periphery of the inner ring fixing portion. The at least two clastic connecting portions are connected between the inner ring fixing portion and the outer ring fixing portion. The inner ring fixing portion is connected to the bracket. The outer ring fixing portion is connected to the core housing, and a radial dimension of the vibration transmitting face-attaching assembly is greater than a radial dimension of the outer ring fixing portion.

In some embodiments, the vibration transmitting face-attaching assembly includes the vibration plate, a soft vibration transmission component, and a hard bracket. A middle region of the soft vibration transmission component is fixed to the vibration plate in molded manner. An edge region of the soft vibration transmission component is fixed to the hard bracket in molded manner. The vibration plate is plug-fitted with the bracket along the spacing direction. The hard bracket is connected to the core housing. A radial dimension of the hard bracket is greater than a radial dimension of the outer ring fixing portion.

The advantageous effect of the present disclosure is that, by setting an angle between the first lead portion and the long axis direction to be less than an angle between the first lead portion and the short axis direction, a length of the first lead portion is increased, thereby effectively reducing a ratio of a tensile length generated when the first lead portion is stretched during vibration of the transducer to a total length of the first lead portion, effectively reducing a possibility that the transducer excessively stretches the first lead portion during a vibration process, effectively improving structural stability and reliability of the speaker assembly, and effectively extending a service life of the speaker assembly.

### BRIEF DESCRIPTION OF THE DRAWINGS

In order to more clearly illustrate the technical solutions in the embodiments of the present disclosure, brief descriptions of the drawings required for the embodiment descriptions are provided below. Obviously, the drawings described below are merely some embodiments of the present disclosure. Those skilled in the art may also derive other drawings based on these drawings without any creative efforts.

FIG. 1 is a schematic diagram illustrating a perspective structure of a headphone according to an embodiment of the present disclosure;

FIG. 2 is a schematic diagram illustrating an exploded structure of the headphone as shown in FIG. 1;

FIG. 3 is a schematic diagram illustrating a usage scenario of the headphone as shown in FIG. 1;

FIG. 4 is a schematic diagram illustrating an exploded structure of a bone conduction speaker as shown in FIG. 2;

FIG. 5 is a schematic diagram illustrating a top view of the bone conduction speaker as shown in FIG. 2 showing a first vibration transmitting plate;

FIG. 6 is a schematic diagram illustrating a top view of the bone conduction speaker as shown in FIG. 2 without showing a first vibration transmitting plate;

FIG. 7 is a schematic diagram illustrating a sectional view taken along a section Z-Z as shown in FIG. 1;

FIG. 8 is a schematic diagram illustrating a perspective structure of a core housing as shown in FIG. 4;

FIG. 9 is a schematic diagram illustrating a bottom view of a partial structure of a transducer as shown in FIG. 4;

FIG. 10 is another schematic diagram illustrating an exploded structure of a bone conduction speaker as shown in FIG. 2;

FIG. 11 is a schematic diagram illustrating a partially exploded structure of a transducer as shown in FIG. 10;

FIG. 12 is a schematic diagram illustrating a bottom view of a partial structure of a transducer as shown in FIG. 10;

FIG. 13 is a schematic diagram illustrating a top view of a bone conduction speaker as shown in FIG. 2 without showing a vibration plate;

FIG. 14 is a schematic diagram illustrating a perspective structure of a vibration plate as shown in FIG. 10;

FIG. 15 is another schematic diagram illustrating an exploded structure of a bone conduction speaker as shown in FIG. 2;

FIG. 16 is a schematic diagram illustrating a bottom view of a bone conduction speaker as shown in FIG. 2;

FIG. 17 is a schematic diagram illustrating an overall structure of a transducer according to an embodiment of the present disclosure;

FIG. 18 is a schematic diagram illustrating an exploded structure of partial components of the transducer shown in FIG. 17;

FIG. 19 is a schematic diagram illustrating a sectional structure of the transducer shown in FIG. 17 along a cutting direction a-a;

FIG. 20 is a schematic diagram illustrating a top view of the transducer shown in FIG. 17;

FIG. 21 is a schematic diagram illustrating a comparison between a perimeter of an outer edge of an outer ring fixing portion and a total width of a notch in the outer edge of the outer ring fixing portion in the transducer shown in FIG. 20;

FIG. 22 is a schematic diagram illustrating another sectional structure of the transducer shown in FIG. 17 along a cutting direction a-a;

FIG. 23 is a schematic diagram illustrating an enlarged structure of a region I of the transducer shown in FIG. 19;

FIG. 24 is a schematic diagram illustrating an overall structure of partial components of a bone conduction speaker in the headphone shown in FIG. 2;

FIG. 25 is a schematic diagram illustrating a sectional structure of the bone conduction speaker shown in FIG. 24 along a cutting direction b-b;

FIG. 26 is a schematic diagram illustrating a structure of a first vibration transmitting plate in the bone conduction speaker shown in FIG. 24;

FIG. 27 is a schematic diagram illustrating an exploded structure of partial components of the bone conduction speaker shown in FIG. 24;

FIG. 28 is a schematic diagram illustrating a structure of a second vibration transmitting plate in the transducer shown in FIG. 17; and

FIG. 29 is a schematic diagram illustrating another structure of a second vibration transmitting plate in the transducer shown in FIG. 17.

### DETAILED DESCRIPTION

The present disclosure is further described in detail below with reference to the drawings and the embodiments. Particular attention is drawn to the fact that the following embodiments are merely provided for illustrating the present disclosure and are not intended to limit a scope of the present disclosure. Similarly, the following embodiments are only part of the embodiments of the present disclosure rather than all the embodiments. All other embodiments obtained by those skilled in the art without any creative effort shall fall within the protection scope of the present disclosure.

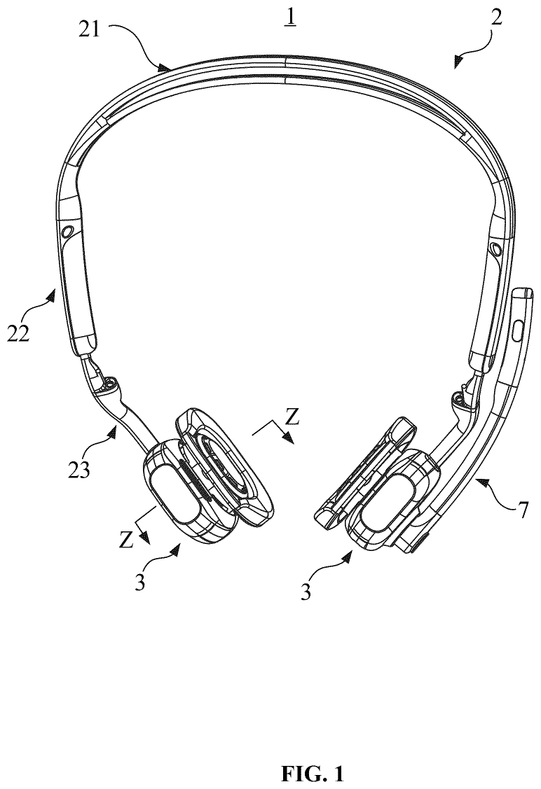

As shown in FIG. 1, a headphone I may include a wearing assembly 2, a speaker assembly 3, and a boom microphone assembly 7. A count of the speaker assemblies 3 may be two. The two speaker assemblies 3 are respectively configured to transmit vibration and/or sound to a left car and a right car of a user. The two speaker assemblies 3 may be the same or different. For example, one speaker assembly 3 may be provided with the boom microphone assembly 7, while the other speaker assembly 3 may not be provided with the boom microphone assembly 7.

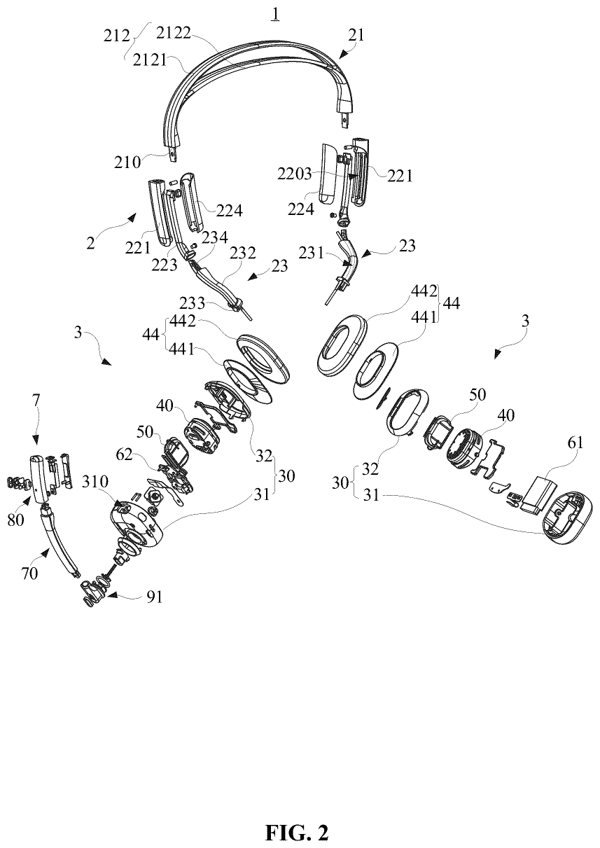

As shown in FIG. 2, the wearing assembly 2 may include a headband assembly 21, a plurality of telescopic assemblies 22, and a plurality of torsion assemblies 23. A count of the telescopic assemblies 22 may be two, and a count of the torsion assemblies 23 may also be two. Two ends of the headband assembly 21 are respectively connected to the two telescopic assemblies 22, and the two telescopic assemblies 22 are respectively connected to the two torsion assemblies 23. The two torsion assemblies 23 are respectively connected to the two speaker assemblies 3. The headband assembly 21 is configured to bypass a top of the head of a user. A shape of the headband assembly 21 may match a contour of the head of the user, so that wearing the headband assembly 21 is more comfortable and stable for the user. The headband assembly 21 is further configured to elastically clamp two sides of the head of the user. Each telescopic assembly 22 is capable of performing a telescopic motion to change a length thereof, thereby changing a distance between the headband assembly 21 and the speaker assembly 3, so as to adaptively adjust based on different head shapes of users and enable the speaker assembly 3 to be positioned at a proper location, thereby improving compatibility of the wearing assembly 2. Each torsion assembly 23 is capable of generating an elastic torsion, and is configured to twist when the speaker assembly 3 comes into contact with the head of the user in a wearing state, so that the speaker assembly 3 can better fit a face of the user or be positioned at an car.

As shown in FIG. 2, the headband assembly 21 may include a clamping assembly 210 and a first clastic covering body 212. The clamping assembly 210 may include an elastic sheet and is configured to implement an elastic clamping function. The first elastic covering body 212 may include a covering main body 2121 and an elastic strap 2122 integrally formed with the covering main body 2121. The covering main body 2121 is disposed in molded manner to cover a periphery of the clamping assembly 210 and a lead wire. Two ends of the elastic strap 2122 are spaced apart from each other in a length direction of the clamping assembly 210 and are respectively connected to the covering main body. Between connection locations of the two ends of the elastic strap 2122 and the covering main body 2121, the elastic strap 2122 is separated from the covering main body 2121. The elastic strap 2122 is configured to assist in positioning the clamping assembly 210 onto the head of the user in the wearing state.

As shown in FIG. 2, the telescopic assembly 22 may include a fixing portion 221 and a telescopic portion 223 telescopically disposed relative to the fixing portion 221. Two ends of the clamping assembly 210 are respectively fixed to the corresponding fixing portions 221, for example, through a plug-in connection. The telescopic assembly 22 may include a decorative portion 224. The fixing portion 221 is provided with a sliding groove 2203, and the telescopic portion 223 is slidably disposed in the sliding groove 2203. The decorative portion 224 is assembled and fixed to the fixing portion 221 (for example, in a covering manner) to cover the sliding groove 2203 and a portion of the telescopic portion 223 located inside the sliding groove 2203.

As shown in FIG. 2, the torsion assembly 23 may include an elastic connecting member 231, a second elastic covering body 232, and a first plug-in portion 233, and a second plug-in portion 234 disposed at two ends of the clastic connecting member 231. The elastic connecting member 231 is schematically shown in FIG. 2 with a dashed line. The second elastic covering body 232 is disposed in molded manner to cover a periphery of the elastic connecting member 231, and the lead wire may pass through the second elastic covering body 232. The first plug-in portion 233 is plug-fitted with a socket 310 of the speaker assembly 3, and the second plug-in portion 234 is plug-fitted with a socket (not labeled) of the telescopic portion 223.

As shown in FIG. 2, the speaker assembly 3 may include a housing assembly 30, a bone conduction speaker 40, and an air conduction speaker 50. The speaker assembly 3 may further include at least one of a battery 61 or a control circuit board 62. The housing assembly 30 is configured to accommodate the bone conduction speaker 40 and the air conduction speaker 50. The bone conduction speaker 40 is configured to fit a face of a user, and the air conduction speaker 50 is configured to transmit air-conducted sound waves to an car canal of the user. When the headphone 1 is worn on the head of the user, the wearing assembly 2 is configured to position the speaker assembly 3 at a facial region on a front side of a tragus of the user.

As shown in FIG. 2, the housing assembly 30 may include a main housing 31 and a main cover 32. The main housing 31 may have an open end, and the main cover 32 is fitted over the open end of the main housing 31. The main cover 32 may be provided with a sound outlet (not labeled) for the air conduction speaker 50 to emit sound. A portion of the bone conduction speaker 40 may be exposed through the open end of the main housing 31 and configured to fit the face of the user. A vibration direction of the bone conduction speaker 40 may be perpendicular to a vibration direction of the air conduction speaker 50, and the bone conduction speaker 40 and the air conduction speaker 50 are assembled to the main housing 31 in such a manner that the vibration directions are perpendicular to each other, so as to reduce mutual interference between the bone conduction speaker 40 and the air conduction speaker 50. To improve comfort in facial contact, the bone conduction speaker 40 may be provided with an auxiliary face-attaching assembly 44. The auxiliary face-attaching assembly 44 is configured to increase a contact area between the bone conduction speaker 40 and the face of the user in the wearing state, thereby improving wearing comfort. The auxiliary face-attaching assembly 44 may include a hard supporting member 441 and a soft fitting member 442. The hard supporting member 441 is configured to support the soft fitting member 442 to improve structural strength and stability of the auxiliary face-attaching assembly 44. The soft fitting member 442 is configured to fit the face of the user and face the user, and is capable of stably and closely fitting the face of the user under support of the hard supporting member 441.

As shown in FIG. 2, the speaker assembly 3 may include at least one of a control circuit board 62 or a battery 61. For example, one speaker assembly 3 may include the control circuit board 62, while the other speaker assembly 3 may not include the control circuit board 62 but may include the battery 61. A connecting lead wire between the two speaker assemblies 3 may pass through the wearing assembly 2. For example, one speaker assembly 3 may include both the control circuit board 62 and the battery 61. Alternatively, a count of the control circuit boards 62 may be two, and each of the speaker assemblies 3 may include one control circuit board 62, respectively. A count of battery 61 may also be two, and each of the speaker assemblies 3 may include one battery 61, respectively.

The boom microphone assembly 7 is rotatably disposed on the speaker assembly 3. The boom microphone assembly 7 may include a boom body assembly 70, a microphone assembly 80, and a rotating shaft mechanism 91. The microphone assembly 80 and the rotating shaft mechanism 91 may be connected to two ends of the boom body assembly 70, and the rotating shaft mechanism 91 is rotatably connected to the speaker assembly 3. In the wearing state, the rotating shaft mechanism 91 may rotate relative to the speaker assembly 3 to position the microphone assembly 80 in a pickup region of a mouth of the user. The microphone assembly 80 is provided with at least one microphone and a related button, which is configured to enable or disable the microphone.

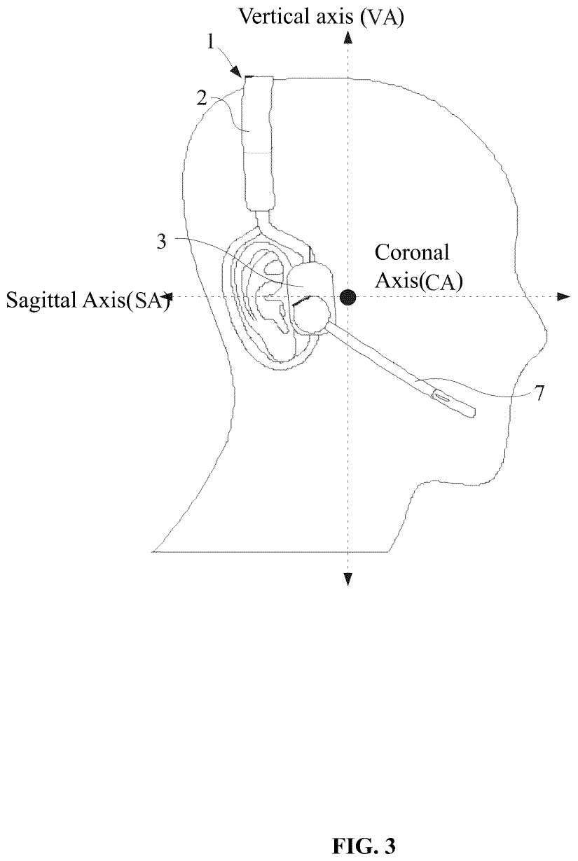

In the fields of medicine, anatomy, or the like, three fundamental planes (i.e., a sagittal plane, a coronal plane, and a horizontal plane) and three fundamental axes (i.e., a sagittal axis (SA), a coronal axis (CA), and a vertical axis (VA)) of the human body may be defined. The sagittal plane refers to a vertical plane perpendicular to the ground and oriented in a front-to-back direction of the body, dividing the human body into left and right portions. The coronal plane refers to a vertical plane perpendicular to the ground and oriented in a left-to-right direction of the body, dividing the human body into front and rear portions. The horizontal plane refers to a plane parallel to the ground and oriented in an up-and-down direction of the body, dividing the human body into upper and lower portions. Correspondingly, the sagittal axis (SA) refers to an axis oriented in the front-to-back direction of the body and perpendicular to the coronal plane. The coronal axis (CA) refers to an axis oriented in the left-to-right direction of the body and perpendicular to the sagittal plane. The vertical axis (VA) refers to an axis oriented in the up-and-down direction of the body and perpendicular to the horizontal plane. As shown in FIG. 3, when the headphone 1 is in the wearing state, the wearing assembly 2 is clamped to two sides of the head of the user, and the speaker assembly 3 is positioned, along the sagittal axis (SA) direction, at a facial arca on a front side of a tragus of the user.

The following descriptions provide detailed explanations of the headphone 1 or some of the components and structures mentioned above. Notably, certain structures or components mentioned above, such as the bone conduction speaker 40 and the air conduction speaker 50, are not limited to use in the headphone 1 and may also be used in other electronic devices, such as mobile phones, speakers, smart wearable devices, or the like.

Optionally, as shown in FIGS. 2-3, and 4, in some embodiments, the speaker assembly 3 may include the bone conduction speaker 40. The bone conduction speaker 40 includes a core housing 41, a first vibration transmitting plate 45, a transducer 42, a vibration plate 431, and a lead wire 46.

The first vibration transmitting plate 45 includes an inner ring fixing portion 451, an outer ring fixing portion 452, and at least two elastic connecting portions 453. The outer ring fixing portion 452 is disposed around a periphery of the inner ring fixing portion 451. The at least two elastic connecting portions 453 are connected between the inner ring fixing portion 451 and the outer ring fixing portion 452. The inner ring fixing portion 451 is connected to the transducer 42, and the outer ring fixing portion 452 is connected to the core housing 41, so that the transducer 42 is suspended in the core housing 41. The vibration plate 431 is connected to the transducer 42.

The lead wire 46 is connected to the transducer 42 and includes a first lead portion 461 extending from the inner ring fixing portion 451 to the outer ring fixing portion 452. When viewed along a vibration direction z1 of the vibration plate 431, the first vibration transmitting plate 45 has a long axis direction LD1 and a short axis direction SD1 that are perpendicular to each other. A dimension ld1 of the first vibration transmitting plate 45 along the long axis direction LD1 is larger than a dimension sd1 of the first vibration transmitting plate 45 along the short axis direction SD1. An angle between the first lead portion 461 and the long axis direction LD1 is less than an angle between the first lead portion 461 and the short axis direction SD1.

The first vibration transmitting plate 45 includes the inner ring fixing portion 451, the outer ring fixing portion 452, and the at least two elastic connecting portions 453, the inner ring fixing portion 451 and the outer ring fixing portion 452 are respectively connected to the transducer 42 and the core housing 41, so that the transducer 42 is suspended in the core housing 41. The transducer 42 is movable relative to the core housing 41, enabling the transducer 42 to vibrate inside the core housing 41. As a result, the speaker assembly 3 is capable of converting sound into mechanical vibrations of different frequencies, and, when worn on the head of the user via the wearing assembly 2, directly conducts sound through contact with a checkbone of the user's face, thereby achieving a good sound transmission effect and effectively improving sound quality of the headphone 1. A count of the elastic connecting portions 453 may be 2, 4, 6, 8, or the like, and may also be any other suitable count. Notably, the first lead portion 461 is disposed between two adjacent clastic connecting portions 453.

The lead wire 46 is connected to the transducer 42 and is configured to transmit an electrical signal to the transducer 42. By setting the angle between the first lead portion 461 and the long axis direction LD1 to be less than the angle between the first lead portion 461 and the short axis direction SD1, a length of the first lead portion 461 is increased, thereby effectively reducing a ratio of a tensile length generated when the first lead portion 461 is stretched during vibration of the transducer 42 to a total length of the first lead portion 461. As a result, a possibility that the transducer 42 excessively stretches the first lead portion 461 during a vibration process is effectively reduced, structural stability and reliability of the speaker assembly 3 are effectively improved, and a service life of the speaker assembly 3 is effectively extended.

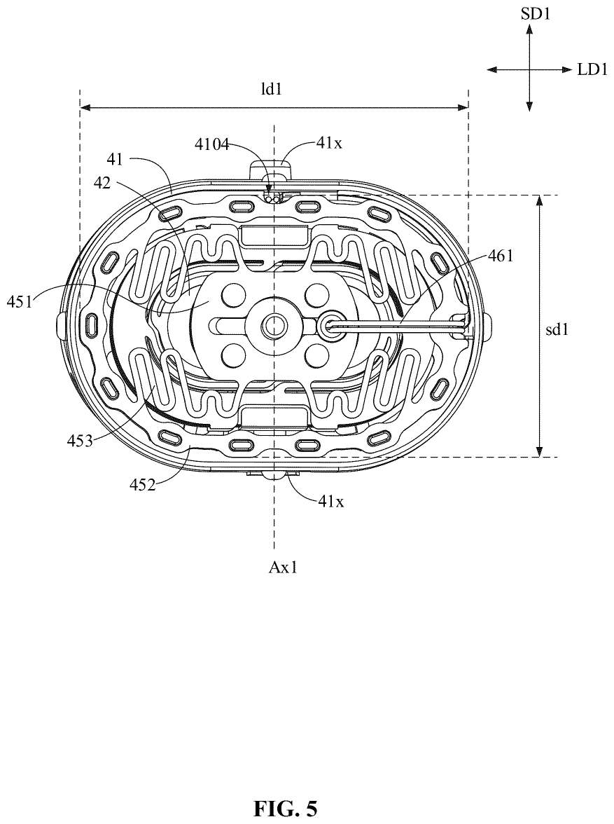

Optionally, as shown in FIG. 5, the first lead portion 461 is arranged along the long axis direction LD1, the angle between the first lead portion 461 and the long axis direction LD1 is 0°, and the angle between the first lead portion 461 and the short axis direction SD1 is 90°. By arranging the first lead portion 461 along the long axis direction LD1, positioning of the first lead portion 461 is facilitated and the length of the first lead portion 461 can be further increased, thereby effectively reducing a possibility that the transducer 42 excessively stretches the first lead portion 461 during the vibration process, effectively improving the structural stability and reliability of the speaker assembly 3, and effectively extending the service life of the speaker assembly 3. In some embodiments, the angle between the first lead portion 461 and the long axis direction LD1 may be 10°, and the angle between the first lead portion 461 and the short axis direction SD1 may be 80°. In some embodiments, the angle between the first lead portion 461 and the long axis direction LD1 may be 20°, and the angle between the first lead portion 461 and the short axis direction SD1 may be 70°. In some embodiments, the angle between the first lead portion 461 and the long axis direction LD1 may be 30°, and the angle between the first lead portion 461 and the short axis direction SD1 may be 60°.

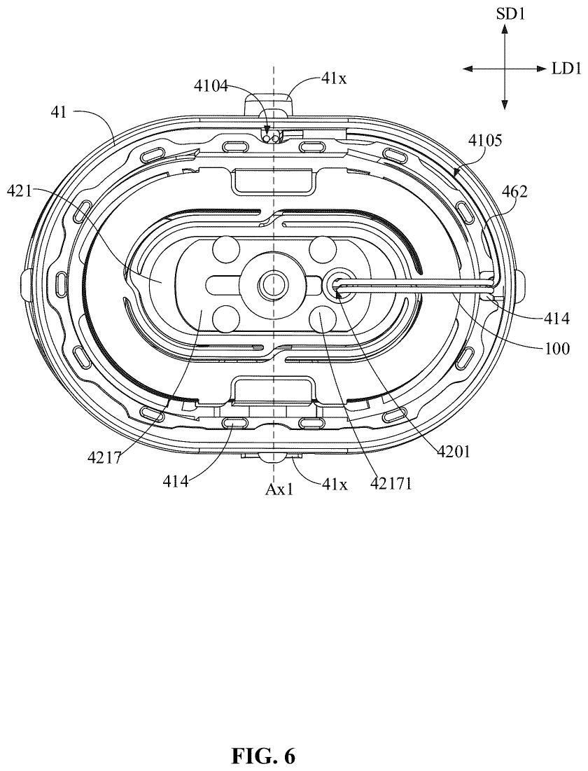

Optionally, as shown in FIGS. 5 and 6, the core housing 41 is provided with rotating shaft mechanisms 41x spaced apart from each other along the short axis direction SD1, the rotating shaft mechanisms 41x are configured to define a rotation axis Ax1 for the core housing 41 to rotate around, the lead wire 46 includes a second lead portion 462, and the second lead portion 462 is connected to an end of the first lead portion 461 close to the outer ring fixing portion 452 and extends toward the rotating shaft mechanisms 41x along a circumferential direction of the core housing 41.

By configuring the rotating shaft mechanisms 41x to allow the core housing 41 to rotate around the rotation axis Ax1, and by configuring the second lead portion 462 to be connected to the end of the first lead portion 461 close to the outer ring fixing portion 452 and to extend toward the rotating shaft mechanisms 41x along the circumferential direction of the core housing 41, a stretching or shaking degree of the second lead portion 462 during rotation of the core housing 41 can be effectively reduced, thereby reducing a possibility of excessive stretching of the second lead portion 462, effectively improving the structural stability and reliability of the speaker assembly 3, and effectively extending the service life of the speaker assembly 3.

Optionally, as shown in FIG. 6, a lead slot 4105 is arranged on the core housing 41 along the circumferential direction of the core housing 41, and the second lead portion 462 is embedded in the lead slot 4105. By providing the lead slot 4105 to accommodate the second lead portion 462, positioning and installation of the second lead portion 462 can be facilitated, while effectively protecting and securing the second lead portion 462. Additionally, the possibility of interference between the second lead portion 462 and other components can be reduced, thereby effectively improving the operational reliability of the speaker assembly 3.

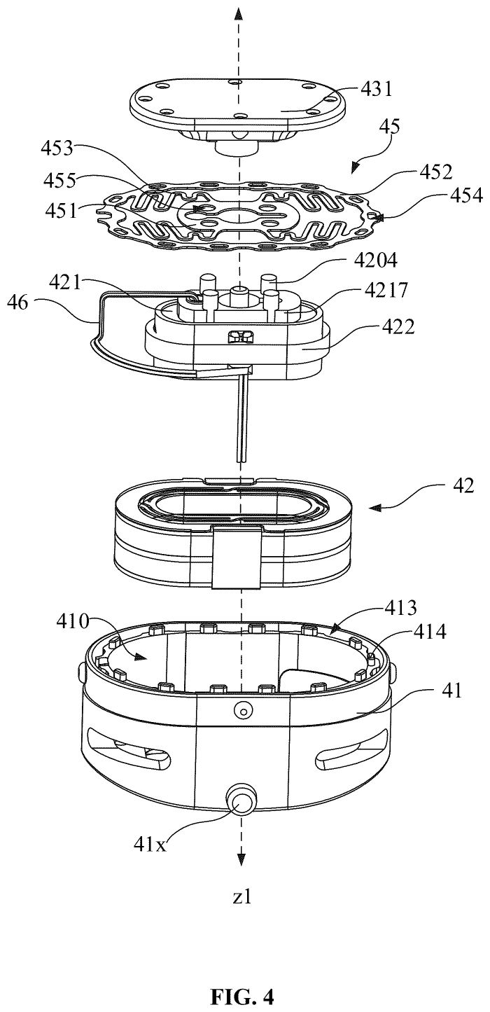

Optionally, as shown in FIGS. 4 and 6, a first hollow area 454 is arranged on the outer ring fixing portion 452, a first embedded block 414 is arranged on the core housing 41, the first embedded block 414 is further embedded in the first hollow area 454, the lead slot 4105 further extends to the first embedded block 414, the first vibration transmitting plate 45 is a metal member, and the first embedded block 414 is a plastic member. The first vibration transmitting plate 45 may be made of a demagnetized metal material, such as demagnetized stainless steel, demagnetized aluminum alloy, or the like.

By configuring the first hollow area 454 and the first embedded block 414 in a matched manner to achieve the connection between the first vibration transmitting plate 45 and the core housing 41, a simple structure is obtained, which facilitates assembly and effectively improves assembly efficiency. The first vibration transmitting plate 45 is, for example, a metal member, and the first embedded block 414 is, for example, a plastic member, that is, a hardness of the first embedded block 414 is lower than a hardness of the first vibration transmitting plate 45. The first embedded block 414 can be embedded in the first hollow area 454 by undergoing a certain elastic deformation, so that an interference fit can be formed between them to improve connection stability. The lead slot 4105 further extends to the first embedded block 414 to position and install the lead wire 46, thereby effectively protecting the lead wire 46, reducing a possibility that the lead wire 46 is damaged by the outer ring fixing portion 452 during vibration of the transducer 42, and being beneficial to improving operating stability and reliability of the speaker assembly 3.

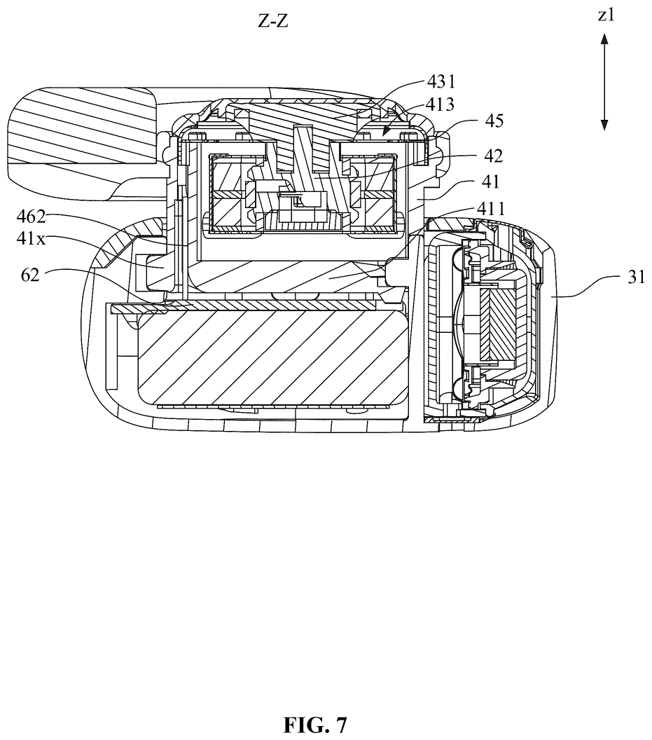

Optionally, as shown in FIG. 6 and FIG. 7, a housing lead hole 4104 is arranged on the core housing 41, an extension direction of the housing lead hole 4104 intersects with the rotation axis Ax1, and the second lead portion 462 further passes through the housing lead hole 4104 and is configured to connect the control circuit board 62.

By providing the housing lead hole 4104 to electrically connect the second lead portion 462 and the control circuit board 62, the control circuit board 62 is allowed to output an electrical signal and transmit the electrical signal to the transducer 42, which is beneficial to improving the operational stability and reliability of the speaker assembly 3. Since an extension direction of the housing lead hole 4104 intersects with the rotation axis Ax1, a tensile stress applied to the second lead portion 462 during rotation of the core housing 41 is effectively reduced, which is also beneficial to improving the operational stability and reliability of the speaker assembly 3.

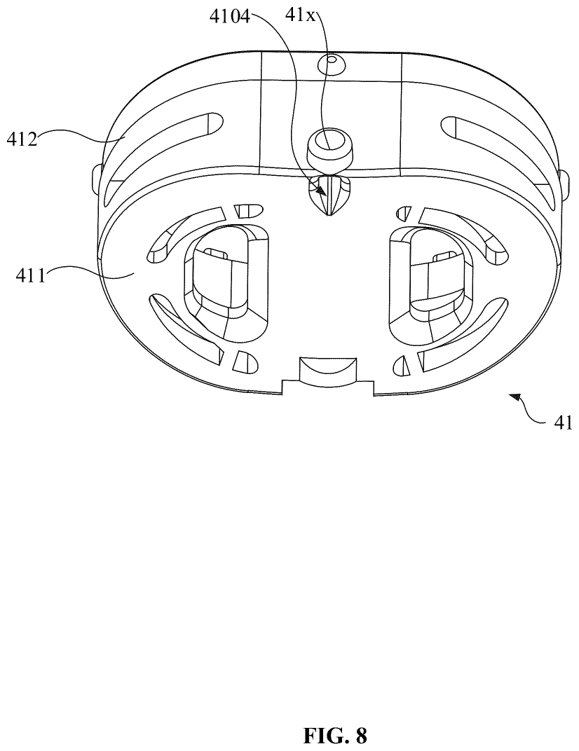

Optionally, as shown in FIG. 2, FIG. 4, and FIG. 8, the speaker assembly 3 further includes a main housing 31. The core housing 41 includes a bottom wall 411 and a peripheral wall 412 connected to the bottom wall 411 to form an accommodation space 410 with an opening at one end. The transducer 42 is arranged in the accommodation space 410. The housing lead hole 4104 is arranged on the bottom wall 411. The rotating shaft mechanisms 41x are arranged on the peripheral wall 412. The rotating shaft mechanism 41x rotationally supports the core housing 41 on the main housing 31. The control circuit board 62 is arranged in the main housing 31 and is located on a side of the bottom wall 411 of the core housing 41 away from the transducer 42.

By disposing the transducer in the accommodation space, arranging the housing lead hole on the bottom wall, and arranging the control circuit board on the side of the bottom wall of the core housing away from the transducer, the connection between the second lead portion and the control circuit board is achieved through the housing lead hole while a length required for the second lead portion to extend through the housing lead hole is reduced, thereby effectively improving a layout rationality and space utilization of the speaker assembly and improving in structural integration of the speaker assembly.

Optionally, as shown in FIG. 7, along the vibration direction z1 of the vibration plate 431, a distance from the rotating shaft mechanism 41x to the bottom wall 411 is smaller than a distance from the rotating shaft mechanism 41x to an open end 413 of the core housing 41, that is, the rotating shaft mechanism 41x is closer to the bottom wall 411 than to the open end 413, so as to provide a larger accommodation space 410 for the control circuit board 62 and reduce a possibility that other components interfere with the control circuit board 62, thereby improving in working stability and reliability of the speaker assembly 3.

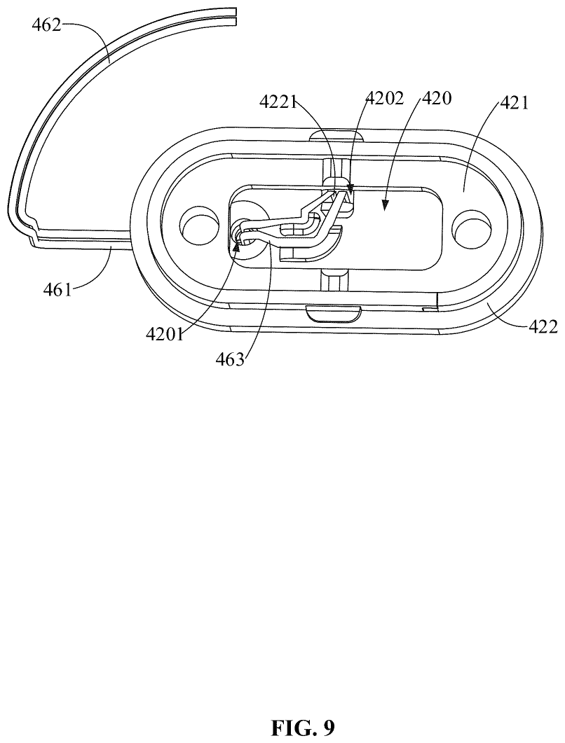

Optionally, as shown in FIG. 4 and FIG. 9, the transducer 42 includes a bracket 421 and a coil 422 arranged on the bracket 421, a weight reduction chamber 420 is arranged on the bracket 421, the bracket 421 is connected to the inner ring fixing portion 451, a first bracket lead hole 4201 is arranged on the bracket 421, the first bracket lead hole 4201 is connected to the weight reduction chamber 420 and a side of the bracket 421 close to the inner ring fixing portion 451, the lead wire 46 includes a third lead portion 463, the third lead portion 463 is connected to an end of the first lead portion 461 close to the inner ring fixing portion 451, and extends along the first bracket lead hole 4201 to the weight reduction chamber 420 and is electrically connected to the coil 422.

By arranging the weight reduction chamber 420, a weight of the bracket 421 can be effectively reduced, thereby improving in a vibration effect of the transducer 42. Furthermore, the third lead portion 463 is connected to an end of the first lead portion 461 close to the inner ring fixing portion 451, and extends along the first bracket lead hole 4201 to the weight reduction chamber 420 to be electrically connected to the coil 422, which reduces a possibility that the third lead portion 463 interferes with peripheral components during a vibration process, thereby improving in stability and reliability of an operation of the speaker assembly 3.

Optionally, as shown in FIGS. 4 and 6, a second hollow area 455 is arranged on the inner ring fixing portion 451, a second embedded block 4217 is arranged on the bracket 421, at least a part of the second embedded block 4217 is further embedded in the second hollow arca 455, the first bracket lead hole 4201 is arranged on the second embedded block 4217, the first vibration transmitting plate 45 may be a metal member, and the second embedded block 4217 may be a plastic member. Optionally, the second embedded block 4217 includes a plug post 4204, and the plug post 4204 is further embedded in the second hollow arca 455.

By providing the second hollow arca 455 and the second embedded block 4217 in a matched manner, the connection between the inner ring fixing portion 451 and the bracket 421 may be achieved, the structure is simple and convenient to assemble, thereby effectively improving assembly efficiency. The first vibration transmitting plate 45 may be a metal member, and the second embedded block 4217 may be a plastic member, that is, the second embedded block 4217 has a lower hardness than the first vibration transmitting plate 45. The second embedded block 4217 may be embedded in the second hollow area 455 by undergoing clastic deformation, so that an interference fit is formed between them, which is favorable for improving connection stability. In addition, the first bracket lead hole 4201 is arranged on the second embedded block 4217 to effectively protect the lead wire 46, reduce a possibility that the inner ring fixing portion 451 damages the lead wire 46 during vibration of the transducer 42, and improve structural stability and reliability of the speaker assembly 3.

Optionally, as shown in FIG. 9, the coil 422 is wound around the periphery of the bracket 421. The bracket 421 is provided with a second bracket lead hole 4202, the second bracket lead hole 4202 communicates the weight reduction chamber 420 with the periphery of the bracket 421. A lead end 4221 of the coil 422 is further introduced into the weight reduction chamber 420 via the second bracket lead hole 4202 and are connected to the third lead portion 463.

By providing the second bracket lead hole 4202, the lead end 4221 of the coil 422 is introduced into the weight reduction chamber 420 through the second bracket lead hole 4202, thereby reducing the possibility that the coil 422 interferes with peripheral components during vibration, which is advantageous for improving the working stability and reliability of the speaker assembly 3.

Optionally, as shown in FIGS. 2, 10, and 11, in some embodiments, the speaker assembly 3 may include a bone conduction speaker 40. The bone conduction speaker 40 includes the transducer 42 and the vibration plate 431. The transducer 42 includes a magnetic conductive cover 423, the coil 422, and the bracket 421. The magnetic conductive cover 423 is configured in a cylindrical shape and is provided with connecting holes 4230 that connect an inner wall surface and an outer wall surface of the magnetic conductive cover 423 along a radial direction of the magnetic conductive cover 423. The bracket 421 is arranged on the magnetic conductive cover 423 in molded manner and includes a bracket body 4211, a limiting portion 4212, and a connecting portion 4213. At least a part of the bracket body 4211 is arranged inside the inner wall surface. The limiting portion 4212 is arranged on the outer wall surface. The connecting portion 4213 integrally connects the bracket body 4211 and the limiting portion 4212 through the connecting holes 4230. The limiting portion 4212 is configured to limit the coil 422 arranged on the outer wall surface. The bracket body 4211 is connected to the vibration plate 431.

The bracket 421 is arranged on the magnetic conductive cover 423 in molded manner, thereby simplifying the assembly process between the bracket 421 and the magnetic conductive cover 423 and improving the assembly effect. By providing the connecting portion 4213 in cooperation with the connecting holes 4230, the connection stability and reliability between the bracket 421 and the magnetic conductive cover 423 can be effectively improved. The limiting portion 4212 is configured to limit the coil 422, so as to reduce the possibility of displacement of the coil 422, which is favorable for improving the vibration effect of the transducer 42 and thus for enhancing the operational stability and reliability of the speaker assembly 3. The molded manner may include an injection molding, a compression molding, a thermoplastic molding, or other manners.

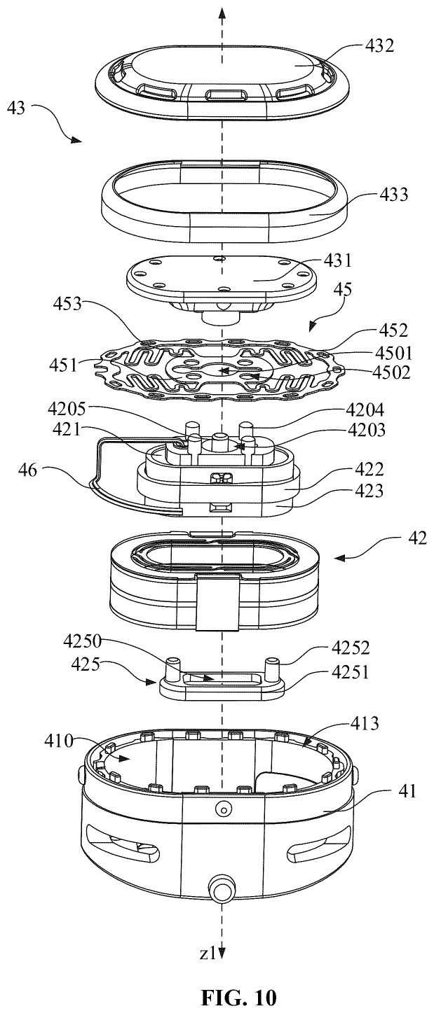

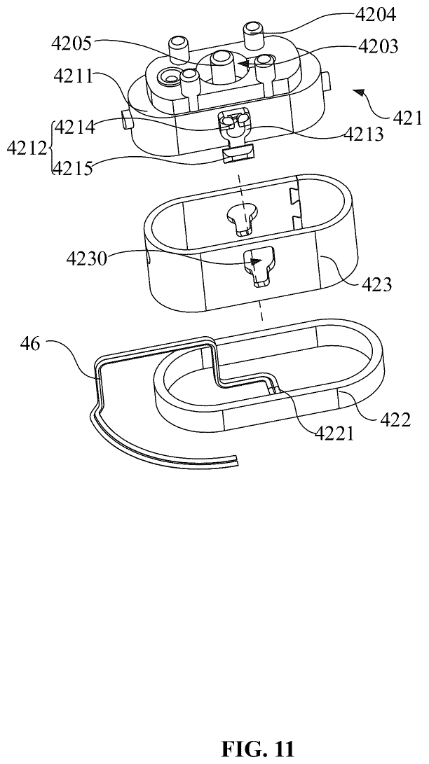

Optionally, as shown in FIGS. 10 and 11, the limiting portion 4212 is configured to abut against the coil 422 in the axial direction of the magnetic conductive cover 423, so that the coil 422 is limited by the limiting portion 4212, thereby facilitating sleeving or winding of the coil 422 onto the magnetic conductive cover 423, effectively reducing the assembly difficulty of the coil 422 and improving assembly efficiency.

In some embodiments, the limiting portion 4212 is arranged in a ring shape along a circumferential direction of the magnetic conductive cover 423, so as to limit the coil 422 disposed on the outer wall surface of the magnetic conductive cover 423, thereby effectively improving the limiting effect.

In some embodiments, the limiting portion 4212 is configured to abut against one side of the coil 422 along the axial direction of the magnetic conductive cover 423, so that the wound coil 422 can be smoothly sleeved on the outer periphery of the magnetic conductive cover 423 and abut against the limiting portion 4212, and another side of the coil 422 is fixed by an adhesive. The limiting portion 4212 limits the coil 422 while simplifying the process flow and reducing assembly difficulty, thereby facilitating improvement in assembly efficiency.

Optionally, as shown in FIG. 10 and FIG. 11, the limiting portion 4212 includes a first sub-limiting portion 4214 and a second sub-limiting portion 4215 spaced apart along the axial direction of the magnetic conductive cover 423, and the coil 422 is wound between the first sub-limiting portion 4214 and the second sub-limiting portion 4215.

By spacing the first sub-limiting portion 4214 and the second sub-limiting portion 4215 apart, the coil 422 is wound between the first sub-limiting portion 4214 and the second sub-limiting portion 4215, so that both sides of the coil 422 can be blocked and limited along the axial direction of the magnetic conductive cover 423, and both sides of the coil 422 can abut against the sub-limiting portions, thereby effectively improving the limiting effect.

Optionally, a material density of the bracket 421 is less than a material density of the magnetic conductive cover 423, which facilitates reducing a weight of the bracket 421, thereby facilitating improvement of a vibration effect of the transducer 42 and facilitating improvement of a sound quality of the speaker assembly 3.

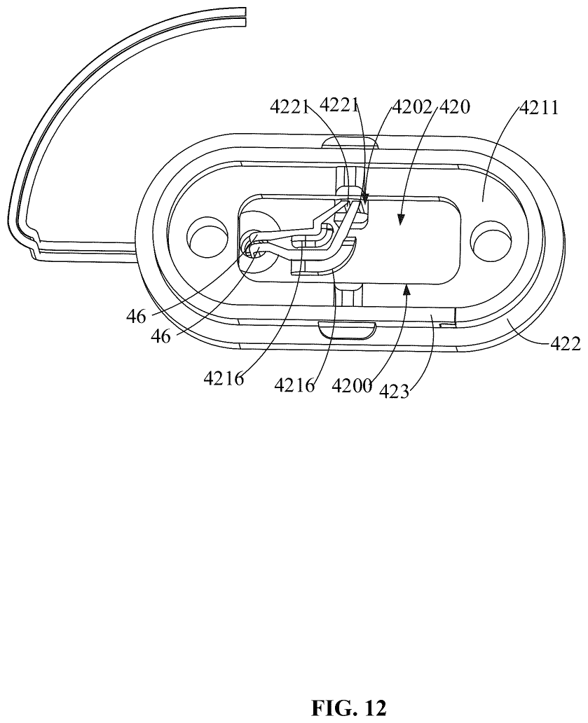

Optionally, as shown in FIG. 12, the weight reduction chamber 420 is arranged on the bracket body 4211, the second bracket lead hole 4202 is arranged on the connecting portion 4213, and the lead end 4221 of the coil 422 further extends into the weight reduction chamber 420 through the second bracket lead hole 4202.

By arranging the weight reduction chamber 420, the weight of the bracket 421 can be effectively reduced, thereby being beneficial to improving a vibration effect of the transducer 42 and achieving weight reduction of the speaker assembly 3. In addition, the lead end 4221 of the coil 422 extends into the weight reduction chamber 420 through the second bracket lead hole 4202. On one hand, the extension of the lead end 4221 of the coil 422 into the weight reduction chamber 420 facilitates the connection between the lead end 4221 of the coil 422 and the lead wire 46, thereby improving assembly convenience. On the other hand, this structure helps reduce a possibility that the lead end 4221 of the coil 422 interfere with peripheral components during vibration, thereby being beneficial to improving operational stability and reliability of the speaker assembly 3.

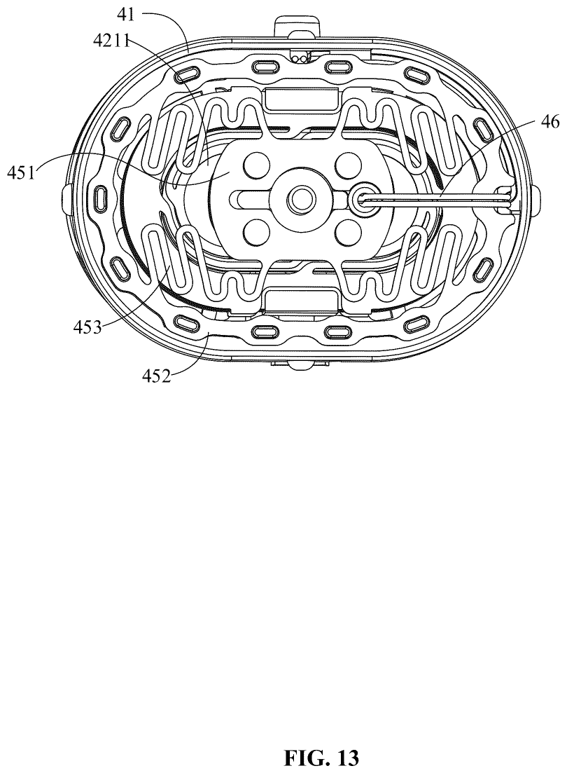

Optionally, as shown in FIGS. 10 and 13, the bone conduction speaker 40 further includes a core housing 41, a first vibration transmitting plate 45, and the lead wire 46. The first vibration transmitting plate 45 includes the inner ring fixing portion 451, the outer ring fixing portion 452, and the at least two elastic connecting portions 453. The outer ring fixing portion 452 is disposed around the periphery of the inner ring fixing portion 451, and the at least two elastic connecting portions 453 are connected between the inner ring fixing portion 451 and the outer ring fixing portion 452. The inner ring fixing portion 451 is connected to the bracket body 4211, the outer ring fixing portion 452 is connected to the core housing 41, and the lead wire 46 is connected to a lead end 4221 of the coil 422 in the weight reduction chamber 420.

The first vibration transmitting plate 45 includes the inner ring fixing portion 451, the outer ring fixing portion 452, and the at least two clastic connecting portions 453, and the inner ring fixing portion 451 and the outer ring fixing portion 452 are connected to the transducer 42 and the core housing 41, respectively, the transducer 42 is suspended in the core housing 41, such that the transducer 42 is movable relative to the core housing 41, thereby enabling the transducer 42 to vibrate inside the core housing 41. Accordingly, the speaker assembly 3 is enabled to convert sound into mechanical vibrations of different frequencies, and the sound is directly transmitted to the checkbone of the user through the wearing assembly 2 in contact with the facial arca, thereby achieving a good sound transmission effect and effectively improving the sound quality of the headphone 1. In addition, the lead wire 46 is connected to the lead end 4221 of the coil 422 in the weight reduction chamber 420, which effectively reduces a possibility of the lead end 4221 of the coil 422 interfering with peripheral components during vibration, and is favorable for improving working stability and reliability of the speaker assembly 3.

Optionally, as shown in FIG. 12, the lead wire 46 includes two groups of wires, the lead end 4221 includes two groups of ends, the two groups of wires connect to the two groups of ends at two connection locations, respectively, a spacing mechanism 4216 is disposed in the weight reduction chamber 420 on the bracket body 4211, and the spacing mechanism 4216 is configured to make the two connection locations maintain a predetermined interval, thereby effectively reducing a possibility of short circuit and being favorable for improving working stability and reliability of the speaker assembly 3.

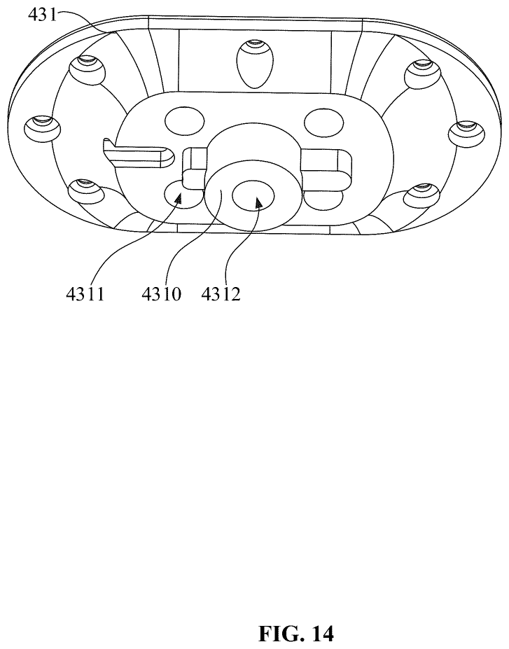

Optionally, as shown in FIG. 10, FIG. 11, and FIG. 14, the bracket body 4211 is provided with a first socket hole 4203 and a plurality of first plug posts 4204 on a side of the bracket body 4211 facing the inner ring fixing portion 451, the plurality of first plug posts 4204 are arranged around and spaced apart on a periphery of the first socket hole 4203, the inner ring fixing portion 451 is provided with an exposed hole 4501 and a plurality of assembly holes 4502, the plurality of assembly holes 4502 are arranged around and spaced apart on a periphery of the exposed hole 4501, the first socket hole 4203 is exposed through the exposed hole 4501, a first plug post 4204 of the plurality of first plug posts 4204 is inserted into a corresponding assembly hole 4502 of the plurality of assembly holes 4502, the vibration plate 431 is provided with a second plug post 4310 and a plurality of second socket holes 4311, the plurality of second socket holes 4311 are arranged around and spaced apart on a periphery of the second plug post 4310, the second plug post 4310 is plug-fitted with the first socket hole 4203, and the plurality of first plug posts 4204 are plug-fitted with the plurality of second socket holes 4311.

By arranging the second plug post 4310 to be plug-fitted with the first socket hole 4203 and the plurality of first plug posts 4204 to be plug-fitted with the plurality of second socket holes 4311, and by providing the exposed hole 4501 to expose the first socket hole 4203 and providing the plurality of assembly holes 4502 to allow the plurality of first plug posts 4204 to be inserted into the plurality of second socket holes 4311 through the plurality of assembly holes 4502, the connection among the bracket 421, the first vibration transmitting plate 45, and the vibration plate 431 is implemented, thereby effectively simplifying the structure, reducing the assembly difficulty, facilitating enhancement of a fixing effect among the bracket 421, the first vibration transmitting plate 45, and the vibration plate 431, and effectively improving the connection stability.

Optionally, as shown in FIG. 11 and FIG. 14, the bracket body 4211 is further provided with a third plug post 4205 located in the first socket hole 4203, the vibration plate 431 is provided with a third socket hole 4312 located on the second plug post 4310, and the third plug post 4205 is plug-fitted with the third socket hole 4312.

By providing the plug-fitted third plug post 4205 and third socket hole 4312 to further connect and fix the bracket 421 and the vibration plate 431, the connection stability and reliability are effectively improved.

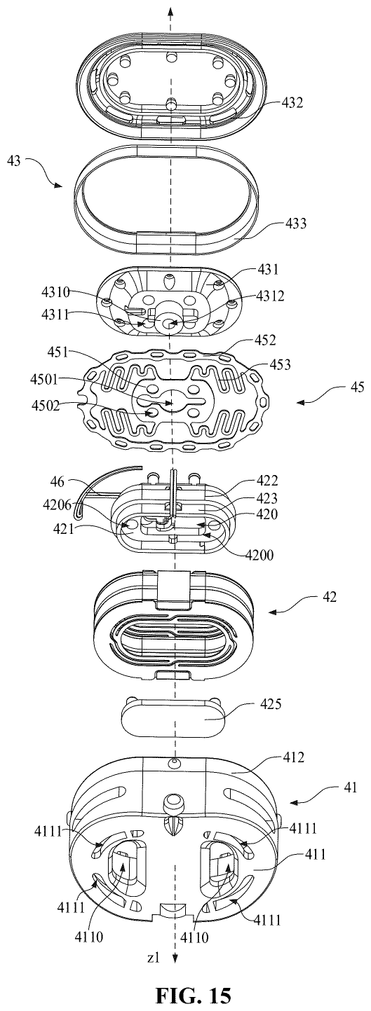

Optionally, as shown in FIG. 2, FIG. 10, and FIG. 15, in some embodiments, the speaker assembly 3 may include the bone conduction speaker 40. The bone conduction speaker 40 includes the core housing 41, the first vibration transmitting plate 45, the vibration plate 431, the transducer 42, and a cover 425. The transducer 42 includes the bracket 421. The first vibration transmitting plate 45 is connected to the bracket 421 and the core housing 41 to suspend the transducer 42 in the core housing 41. The vibration plate 431 is connected to the bracket 421. The bracket 421 is provided with a first weight reduction chamber 420 located inside the core housing 41 and having an open end 4200, and the cover 425 is configured to cover the open end 4200 of the first weight reduction chamber 420.

By suspending the transducer 42 in the core housing 41, the transducer 42 is movable relative to the core housing 41, so that the transducer 42 is capable of vibrating inside the core housing 41, thereby enabling the speaker assembly 3 to convert electrical signals into mechanical vibrations of different frequencies, and utilizing the wearing assembly 2 to achieve direct transmission of sound by contacting the checkbone of the face of the user, so as to achieve a good sound transmission effect. By providing the first weight reduction chamber 420, the weight of the bracket 421 can be effectively reduced, thereby facilitating improvement of the vibration effect of the transducer 42, enabling overall lightweight design of the headphone 1, contributing to enhanced operational stability and reliability of the speaker assembly 3, and facilitating improvement of the sound quality of the headphone 1.

In addition, since the transducer 42 generates sound waves while vibrating inside the core housing 41, if the first weight reduction chamber 420 is not covered, the first weight reduction chamber 420 would be in communication with an acoustic cavity in the core housing 41 for sound wave vibration, resulting in an increased volume of the acoustic cavity for sound wave vibration and thereby causing increased sound leakage. Therefore, by providing the cover 425 to cover the open end 4200 of the first weight reduction chamber 420, the volume of the acoustic cavity for sound wave vibration is reduced, so that a frequency of the leaked sound wave shifts to a high frequency that is less perceivable by the human car, thereby reducing sound leakage in the voice frequency band and effectively improving the sound transmission effect and sound quality of the speaker assembly 3.

Optionally, as shown in FIG. 10 and FIG. 15, the core housing 41 includes the bottom wall 411 and the peripheral wall 412 connected to the bottom wall 411 to form the accommodation space 410 with an open end at one side, the transducer 42 is arranged in the accommodation space 410, and the open end 4200 of the first weight reduction chamber 420 is arranged facing the bottom wall 411.

By arranging the open end 4200 of the first weight reduction chamber 420 facing the bottom wall 411, the open end 4200 of the first weight reduction chamber 420 can be conveniently covered by the cover 425 without hindering the transmission of sound waves to the user, thereby effectively improving the sound transmission effect and sound quality of the speaker assembly 3.

Optionally, as shown in FIG. 10 and FIG. 15, the cover 425 is configured to seal the first weight reduction chamber 420 on a side of the open end 4200 of the first weight reduction chamber 420, thereby effectively isolating the first weight reduction chamber 420 from the accommodation space 410, reducing the volume of the acoustic cavity for sound wave vibration, reducing sound leakage in the voice frequency band, and effectively improving the sound transmission effect and sound quality of the speaker assembly 3.

Optionally, as shown in FIG. 10, a second weight reduction chamber 4250 is provided on a side of the cover 425 facing the first weight reduction chamber 420, and the first weight reduction chamber 420 is in communication with the second weight reduction chamber 4250. By providing the second weight reduction chamber 4250 on the cover 425 and configuring the second weight reduction chamber 4250 to be in communication with the first weight reduction chamber 420 instead of the accommodation space 410, the weight of the transducer 42 can be further reduced to improve the vibration performance, while effectively enhancing the sound transmission performance and sound quality of the speaker assembly 3.

Optionally, the cover 425 is detachably connected to the bracket 421. Optionally, as shown in FIG. 9 and FIG. 14, the bracket 421 is arranged with a socket hole 4206 located at a periphery of the first weight reduction chamber 420, the cover 425 includes a cover body 4251 and a plug post 4252 disposed on a side of the cover body 4251, the plug post 4252 is plugged with the socket hole 4206, and the cover body 4251 covers the open end 4200 of the first weight reduction chamber 420.

By configuring the plug post 4252 to be fitted with the socket hole 4206, the detachable connection between the cover 425 and the bracket 421 is achieved, such that the structure is simplified, assembly and disassembly are facilitated, assembly difficulty is effectively reduced, and assembly efficiency is improved.

Optionally, as shown in FIG. 11 and FIG. 12, the transducer 42 further includes the coil 422, the coil 422 is wound around the periphery of the bracket 421, the bracket 421 is provided with the second bracket lead hole 4202, the second bracket lead hole 4202 communicates the first weight reduction chamber 420 and the periphery of the bracket 421, and the lead end 4221 of the coil 422 is further introduced into the first weight reduction chamber 420 through the second bracket lead hole 4202.

By extending the lead end 4221 of the coil 422 into the first weight reduction chamber 420 through the second bracket lead hole 4202, on one hand, the lead end 4221 of the coil 422 being extended into the first weight reduction chamber 420 facilitates the connection between the lead end 4221 of the coil 422 and the lead wire 46, thereby improving assembly convenience; on the other hand, it is advantageous to reduce the possibility of interference between the lead end 4221 of the coil 422 and peripheral components during vibration, which is favorable for improving the operational stability and reliability of the speaker assembly 3.

Optionally, as shown in FIG. 12, the bone conduction speaker 40 further includes the lead wire 46, and the lead wire 46 is configured to be connected with the lead end 4221 of the coil 422 in the first weight reduction chamber 420.

By connecting the lead wire 46 with the lead end 4221 of the coil 422 in the first weight reduction chamber 420 and covering the first weight reduction chamber 420 with the cover 425, while the lead wire 46 transmits an electrical signal to the coil 422, it is advantageous to reduce the possibility of interference between a connecting portion of the lead wire 46 and the lead end 4221 of the coil 422 and the peripheral components during vibration, thereby improving the operational stability and reliability of the speaker assembly 3.

Optionally, as shown in FIG. 11, the transducer 42 further includes the magnetic conductive cover 423. The magnetic conductive cover 423 is configured in a cylindrical shape and is provided with the connecting holes 4230 connecting the inner wall surface and the outer wall surface of the magnetic conductive cover 423 along the radial direction of the magnetic conductive cover 423. The coil 422 is wound around the outer wall surface. The bracket 421 is arranged on the magnetic conductive cover 423 in molded manner and includes the bracket body 4211 and the connecting portion 4213. At least a part of the bracket body 4211 is arranged inside the inner wall surface, the connecting portion 4213 is arranged in the connecting hole 4230, and the second bracket lead hole 4202 is arranged on the connecting portion 4213.

By arranging the bracket 421 on the magnetic conductive cover 423 in molded manner, the assembly process between the bracket 421 and the magnetic conductive cover 423 is simplified and the assembly effect is improved. By arranging the connecting portion 4213 to cooperate with the connecting hole 4230, the connection stability and reliability between the bracket 421 and the magnetic conductive cover 423 are effectively enhanced. The molded manner may include an injection molding, a compression molding, a thermoplastic molding, or other manners.

Optionally, as shown in FIG. 2, FIG. 10, and FIG. 15, in some embodiments, the speaker assembly 3 includes the bone conduction speaker 40. The bone conduction speaker 40 includes the core housing 41, the vibration transmitting face-attaching assembly 43, the first vibration transmitting plate 45, and the transducer 42. The core housing 41 includes the bottom wall 411 and the peripheral wall 412 connected to the bottom wall 411 to form the accommodation space 410 with the open end. The transducer 42 is placed in the accommodation space 410 through the open end 413 of the core housing 41. The transducer 42 includes the bracket 421. The first vibration transmitting plate 45 is connected to the bracket 421 and the core housing 41 to elastically suspend the transducer 42 in the core housing 41. The vibration transmitting face-attaching assembly 43 is assembled and fixed on the bracket 421 along a spacing direction between the bracket 421 and the bottom wall 411. The bottom wall 411 is provided with through holes 4110 opposite to the bracket 421, and the through holes 4110 are configured to allow a support fixture to be inserted into the accommodation space 410 through the through holes 4110 and support the bracket 421 when the vibration transmitting face-attaching assembly 43 is assembled and fixed on the bracket 421.

By configuring the first vibration transmitting plate 45 to connect the bracket 421 and the core housing 41, the transducer 42 is elastically suspended in the core housing 41, such that a relative positional change can occur between the transducer 42 and the core housing 41. The transducer 42 vibrates in the accommodation space 410 and is capable of reducing the vibration transmitted to the core housing 41, thereby reducing sound leakage caused by vibration of the core housing 41. Moreover, the vibration transmitting face-attaching assembly 43 is assembled and fixed on the bracket 421 along the spacing direction between the bracket 421 and the bottom wall 411, so that the speaker assembly 3 is capable of converting the electrical signals into the mechanical vibrations of different frequencies and directly transmitting sound by enabling the vibration transmitting face-attaching assembly 43 to contact the cheekbone of the face of the user. The structural stability and reliability are enhanced while achieving the good sound transmission effect, thereby effectively improving the sound quality of the headphone 1. Optionally, the vibration transmitting face-attaching assembly 43 is plug-fitted, adhesively fitted, or screw-fitted with the bracket 421, and may also be fitted in other manners.

In some embodiments, since the first vibration transmitting plate 45 is mounted in a suspended manner, clastic deformation may occur during the assembly of other components, resulting in misalignment during installation. For example, during the installation of the vibration transmitting face-attaching assembly 43, as the vibration transmitting face-attaching assembly 43 is fixed to the bracket 421, an installation pressing force applied to the bracket 421 may cause the first vibration transmitting plate 45 to deform elastically. Therefore, the bottom wall 411 is provided with the through holes 4110 disposed opposite to the bracket 421, so that when the vibration transmitting face-attaching assembly 43 is assembled and fixed on the bracket 421, the support fixture can be inserted into the accommodation space 410 through the through holes 4110 to provide a supporting force for the bracket 421. As a result, the possibility of deformation of the first vibration transmitting plate 45 is effectively reduced, the positioning and installation accuracy is effectively improved, and the assembly difficulty is reduced while the assembly efficiency and yield rate are improved.

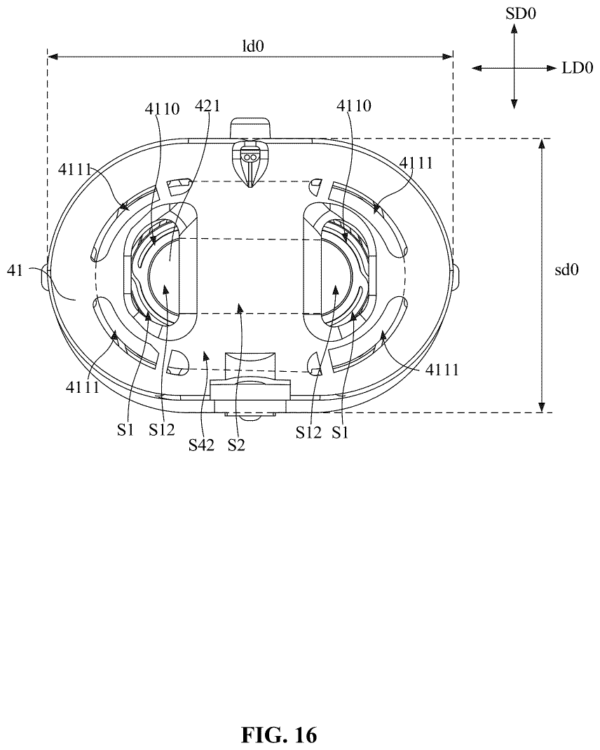

Optionally, as shown in FIG. 16, when viewed along a vibration direction z1 of the transducer 42, the bone conduction speaker 40 has a long axis direction LD0 and a short axis direction SD0, and a dimension Id0 of the bone conduction speaker 40 along the long axis direction LD0 is greater than a dimension sd0 of the bone conduction speaker 40 along the short axis direction SD0. A count of the through holes 4110 is two, and the two through holes 4110 are spaced apart along the long axis direction LD0.

When viewed along the vibration direction z1 of the transducer 42, the bone conduction speaker 40 may be in a shape such as an elliptical shape or an olive shape, and may also be in other shapes. The long axis direction LD0 refers to a direction of a longest segment that passes through the center point and connects two points on the outer edge of the bone conduction speaker 40 on a cross section of the bone conduction speaker 40 perpendicular to the vibration direction z1. The short axis direction SDO refers to a direction of a shortest segment that passes through the center point and connects two points on the outer edge of the bone conduction speaker 40 in the same cross section. The two through holes 4110 are spaced apart along the long axis direction LD0. Compared with spacing them along other directions, such an arrangement can provide a larger operation space for inserting the support fixture in subsequent steps, enabling more stable support of the bracket 421, allowing the bracket 421 and the first vibration transmitting plate 45 to maintain better balance and stability during assembly, thereby effectively improving the stability and reliability of the assembly process of the bone conduction speaker 40.

Optionally, as shown in FIG. 16, in a reference plane perpendicular to the vibration direction z1 of the transducer 42, the through holes 4110 form a first projection region S1 in the reference plane along the vibration direction z1, the bracket 421 forms a second projection region S2 in the reference plane along the vibration direction z1, and a ratio of an area of an overlap region S12 of the first projection region S1 and the second projection region S2 to an area of the second projection region S2 is greater than or equal to 0.3, for example, the ratio of the area of the overlap region S12 of the first projection region S1 and the second projection region S2 to the area of the second projection region S2 is 0.35, 0.5, or 0.65.

If the ratio of the area of the overlap region S12 of the first projection region S1 and the second projection region S2 to the area of the second projection region S2 is too small, the support fixture may fail to stably support the bracket 421, thereby resulting in a reduction in assembly efficiency and assembly accuracy; whereas if the ratio is too large, the support fixture may interfere with other components during use or result in deteriorated structural strength. By reasonably setting the ratio of the area of the overlap region S12 of the first projection region S1 and the second projection region S2 to the area of the second projection region S2, the supporting effect of the support fixture on the bracket 421 can be effectively improved, thereby effectively reducing a possibility of deformation of the first vibration transmitting plate 45, effectively improving positioning and installation accuracy, effectively reducing assembly difficulty, and effectively improving assembly efficiency and production yield rate. In addition, by reasonably arranging the through holes 4110, sound in an inner cavity of the core housing 41 can be guided out to cancel at least part of leakage sound generated by vibration of the core housing 41, thereby effectively improving the sound transmission effect and sound quality of the speaker assembly 3.

Optionally, as shown in FIG. 15 and FIG. 16, the bottom wall 411 is further provided with mounting holes 4111 disposed adjacent to an inner wall surface of the peripheral wall 412, and the mounting holes 4111 are spaced apart from the through holes 4110. The mounting holes 4111 are in communication with the accommodation space 410. The mounting holes 4111 are configured to allow the support fixture to be inserted into the accommodation space 410 through the mounting holes 4111 and support the bracket 421 when the vibration transmitting face-attaching assembly 43 is assembled and fixed on the bracket 421. By providing the mounting holes 4111, the support performance for the bracket 421 can be further improved, thereby effectively improving positioning and installation accuracy, effectively reducing assembly difficulty, and effectively improving assembly efficiency and production yield rate.

Optionally, as shown in FIG. 16, the first projection region S1 formed by the through holes 4110 along the vibration direction z1 in the reference plane and the second projection region S2 formed by the bracket 421 along the vibration direction z1 in the reference plane have the overlap region S12, and the ratio of the area of the overlap region S12 to an area of the first projection region S1 is greater than or equal to 30%. The first projection region S1 and a third projection region S42 formed by the transducer 42 along the vibration direction z1 in the reference plane have an overlap region, and a ratio of an area of the overlap region to the area of the first projection region S1 is greater than or equal to 70%. A projection region formed by the mounting holes 4111 and the through holes 4110 along the vibration direction z1 in the reference plane and the third projection region S42 have an overlap region, and a ratio of an area of the overlap portion to an area of the projection region of the mounting holes 4111 and the through holes 4110 is greater than or equal to 80%. By reasonably setting the above-mentioned ratios, the supporting effect of the support fixture on the bracket 421 can be effectively improved, thereby effectively reducing a possibility of deformation of the first vibration transmitting plate 45, effectively improving positioning and mounting accuracy, effectively reducing assembly difficulty, and effectively improving assembly efficiency and production yield rate.

Optionally, as shown in FIG. 11, the transducer 42 further includes the magnetic conductive cover 423. The magnetic conductive cover 423 is configured in a cylindrical shape and is provided with the connecting hole 4230 that extends along the radial direction of the magnetic conductive cover 423 and connects the inner wall surface and the outer wall surface of the magnetic conductive cover 423. The bracket 421 is arranged on the magnetic conductive cover 423 in molded manner and includes the bracket body 4211 and the connecting portion 4213. At least a part of the bracket body 4211 is arranged inside the inner wall surface, the connecting portion 4213 is arranged in the connecting hole 4230, and the through holes 4110 are arranged opposite to the bracket body 4211.

By arranging the bracket 421 on the magnetic conductive cover 423 in molded manner, the assembling process of the bracket 421 and the magnetic conductive cover 423 is simplified, and the assembling effect is effectively improved. Furthermore, by providing the connecting portion 4213 to fit with the connecting hole 4230, the connection stability and reliability between the bracket 421 and the magnetic conductive cover 423 are effectively enhanced. The vibration transmitting face-attaching assembly 43 is connected to the bracket body 4211 to achieve assembly and fixation with the bracket 421. By configuring the through holes 4110 to be arranged opposite to the bracket body 4211, it is convenient for the support fixture to be inserted and provide supporting force to the bracket body 4211, such that the supporting force is opposite to the pressing force applied to the bracket body 4211 during the installation of the vibration transmitting face-attaching assembly 43, thereby effectively reducing the possibility of deformation of the first vibration transmitting plate 45, effectively improving the positioning and installation accuracy, effectively reducing the assembly difficulty, and effectively improving the assembly efficiency and production yield rate. The molded manner may include an injection molding, a compression molding, a thermoplastic molding, or other molded manners.

Optionally, as shown in FIG. 10 and FIG. 15, the first vibration transmitting plate 45 includes the inner ring fixing portion 451, the outer ring fixing portion 452, and the at least two clastic connecting portions 453. The outer ring fixing portion 452 is disposed around the periphery of the inner ring fixing portion 451. The at least two elastic connecting portions 453 are connected between the inner ring fixing portion 451 and the outer ring fixing portion 452. The inner ring fixing portion 451 is connected to the bracket 421, the outer ring fixing portion 452 is connected to the core housing 41, and a radial dimension of the vibration transmitting face-attaching assembly 43 is greater than a radial dimension of the outer ring fixing portion 452.

By providing the inner ring fixing portion 451, the outer ring fixing portion 452, and the at least two elastic connecting portions 453, the clastic connection between the bracket 421 and the core housing 41 is implemented. In addition, by setting the radial dimension of the vibration transmitting face-attaching assembly 43 to be greater than the radial dimension of the outer ring fixing portion 452, exposure of the first vibration transmitting plate 45 to the outside can be avoided, which is beneficial to improving the structural integrity of the bone conduction speaker 40, enhancing comfort when the headphone 1 contacts the cheekbone of the user, and effectively reducing the foreign matter entering the interior of the bone conduction speaker 40, thereby improving the service life of the headphone 1.

Optionally, as shown in FIG. 10 and FIG. 15, the vibration transmitting face-attaching assembly 43 includes the vibration plate 431, a soft vibration transmission component 432, and a hard bracket 433. A middle region of the soft vibration transmission component 432 is fixed to the vibration plate 431 in molded manner, and an edge region of the soft vibration transmission component 432 is fixed to the hard bracket 433 in molded manner. The vibration plate 431 is plug-fitted with the bracket 421 along the spacing direction, the hard bracket 433 is connected to the core housing 41, and a radial dimension of the hard bracket 433 is greater than a radial dimension of the outer ring fixing portion 452.

By fixing the middle region of the soft vibration transmission component 432 to the vibration plate 431 in molded manner, and fixing the edge region of the soft vibration transmission component 432 to the hard bracket 433 in molded manner, a fitting degree between the soft vibration transmission component 432 and the vibration plate 431 and a fitting degree between the soft vibration transmission component 432 and the hard bracket 433 can be effectively improved, thereby effectively enhancing connection reliability and stability, reducing assembly difficulty, and simplifying the assembly process. The molded manner may include an injection molding, a compression molding, a thermoplastic molding, or other manners. In addition, by plug-fitted the vibration plate 431 with the bracket 421 along the spacing direction and connecting the hard bracket 433 to the core housing 41, vibration can be transmitted from the bracket 421 to the vibration plate 431 and further transmitted to a user, without affecting the suspended installation of the transducer 42, thereby achieving a good sound transmission effect, improving the structural stability and reliability, and effectively enhancing the sound quality of the headphone 1.

Optionally, as shown in FIG. 10 and FIG. 15, the inner ring fixing portion 451 is plug-fitted with the bracket 421 and is clamped between the bracket 421 and the vibration plate 431, so that the structure is simple, the assembly difficulty is reduced, and the assembly process is simplified, thereby improving the assembly efficiency and production yield rate.

Optionally, as shown in FIG. 10 and FIG. 15, the bracket 421 is provided with the first socket hole 4203 and the plurality of first plug posts 4204 on the side facing the inner ring fixing portion 451, the plurality of first plug posts 4204 are arranged around and spaced apart on the periphery of the first socket hole 4203, the inner ring fixing portion 451 is provided with the exposed hole 4501 and the plurality of assembly holes 4502, the plurality of assembly holes 4502 are arranged around and spaced apart on the periphery of the exposed hole 4501, the first socket hole 4203 is exposed through the exposed hole 4501, and the first plug posts 4204 are inserted into corresponding assembly holes 4502. The vibration plate 431 is provided with the second plug post 4310 and the plurality of second socket holes 4311, the plurality of second socket holes 4311 are arranged around and spaced apart on the periphery of the second plug post 4310, the second plug post 4310 is plug-fitted with the first socket hole 4203, and the plurality of first plug posts 4204 are plug-fitted with the plurality of second socket holes 4311.

By configuring the second plug post 4310 to be plug-fitted with the first socket hole 4203 and the first plug posts 4204 to be plug-fitted with the second socket holes 4311, and by providing the exposed hole 4501 to expose the first socket hole 4203, and the assembly holes 4502 to allow the first plug posts 4204 to be inserted into the second socket holes 4311 through the assembly holes 4502, the connection among the bracket 421, the first vibration transmitting plate 45, and the vibration plate 431 is achieved, so that the structure is simplified, assembly difficulty is reduced, the fixing effect among the bracket 421, the first vibration transmitting plate 45, and the vibration plate 431 is improved, and connection stability is effectively enhanced.

Optionally, as shown in FIG. 10 and FIG. 15, the bracket body 421 is further provided with the third plug post 4205 located in the first socket hole 4203, and the vibration plate 431 is provided with the third socket hole 4312 located on the second plug post 4310, and the third plug post 4205 is plug-fitted with the third socket hole 4312.

By providing the plug-fitted third plug post 4205 and third socket hole 4312, the bracket 421 and the vibration plate 431 are further fixedly connected, thereby effectively improving connection stability and reliability.

As shown in FIG. 3, in some embodiments, the headphone I may include the speaker assembly 3 and the wearing assembly 2 connected to the speaker assembly 3. The wearing assembly 2 may be configured to position the speaker assembly 3 at the facial area on the front side of the tragus of the user in the wearing state. The front side of the tragus refers to a side of the tragus facing toward the nose. The speaker assembly 3 may be configured to be placed at the facial arca on the front side of the tragus of the user and be attached to the facial area of the user. The speaker assembly 3 is configured to convert an electric signal containing related audio information into a sound wave signal and a vibration signal.

In some embodiments, as shown in FIG. 2, the speaker assembly 3 may include the bone conduction speaker 40. The bone conduction speaker 40 is configured to convert an electrical signal containing audio information into a vibration signal. The bone conduction speaker 40 may be attached to the facial arca on the front side of the tragus of the user, so that the bone conduction speaker 40 can transmit the vibration signal containing audio information to the user.

In some embodiments, as shown in FIG. 4, the bone conduction speaker 40 may include the transducer 42. The transducer 42 is a main device in the bone conduction speaker 40 for converting an electrical signal into a vibration signal.

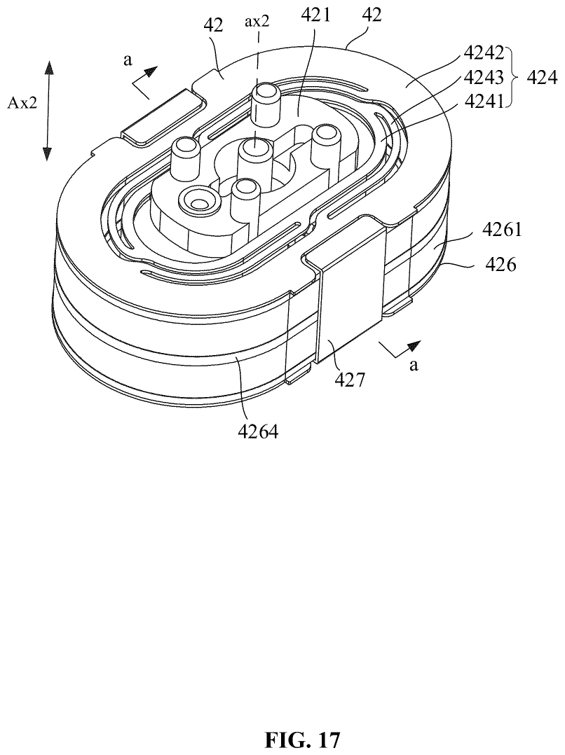

As shown in FIG. 17, the transducer 42 may include a clip 427 and a magnetic circuit system 426. The magnetic circuit system 426 may include at least two annular magnets 4261, which may be stacked along an axial direction Ax2 of the magnetic circuit system 426, and adjacent annular magnets 4261 may be arranged with opposite polarities along the axial direction Ax2. The clip 427 may be configured to clamp two outer end surfaces of the magnetic circuit system 426 away from each other along the axial direction Ax2. The axial direction Ax2 of the transducer 42 is as indicated by the arrow Ax2 in FIG. 17.

Specifically, after the transducer 42 is energized, the magnetic circuit system 426 is capable of generating vibrations along the axial direction Ax2 of the transducer 42 under the action of an electric field and magnetic fields of at least two annular magnets 4261, so as to drive the vibration transmitting face-attaching assembly 43 to vibrate.

The adjacent annular magnets 4261 are arranged with mutually repelling polarities along the axial direction Ax2, such that the entire magnetic circuit system 426 can obtain a stronger magnetic field, thereby enhancing the magnetic field effect in a magnetic gap. However, due to the magnetic repulsion between adjacent annular magnets 4261, they are prone to mutual displacement caused by the repulsion. Moreover, when the magnetic circuit system 426 vibrates, the at least two annular magnets 4261 also move along the axial direction Ax2 during the vibration process. Therefore, whether in motion or at rest, the at least two annular magnets 4261 may easily shift, which may cause looseness of internal components of the transducer 42.

Optionally, as shown in FIG. 17, the clip 427 may be configured to clamp two side surfaces of the at least two annular magnets 4261 away from each other along the axial direction Ax2. Therefore, the clip 427 can fix the at least two annular magnets 4261 at the two side surfaces away from each other, so as to reduce the displacement of the at least two annular magnets 4261 along the axial direction Ax2 caused by repelling polarities or vibrations.

Therefore, by disposing the clip 427 at the two outer end surfaces of the magnetic circuit system 426 away from each other to clamp the magnetic circuit system 426, the relative displacement between the at least two annular magnets 4261 may be limited, so that the transducer 42 is less likely to become loose, which may otherwise result in failure of the conversion function of the transducer 42. Such a clamping configuration may improve structural stability, compactness, and reliability of the transducer 42, and may also extend the service life of the transducer 42.

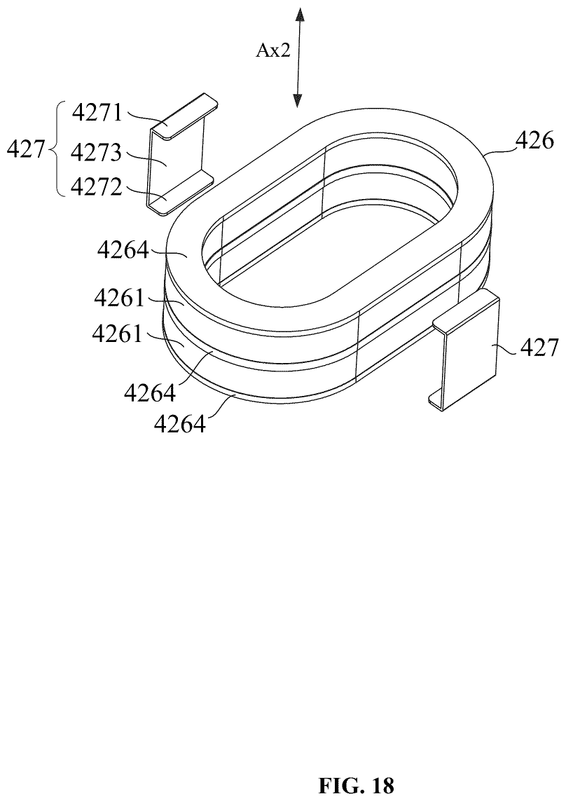

In some embodiments, as shown in FIGS. 17 and 18, the magnetic circuit system 426 may further include at least three annular magnetic conducting plates 4264. The annular magnetic conducting plates 4264 are stacked with the at least two annular magnets 4261 along the axial direction Ax2 of the magnetic circuit system 426. A count of the annular magnetic conducting plates 4264 may correspond to a count of the annular magnets 4261. The annular magnetic conducting plates 4264 and the annular magnets 4261 are alternately stacked, and each annular magnet 4261 is clamped between two adjacent annular magnetic conducting plates 4264.

For example, the count of the annular magnetic conducting plates 4264 may be three, and the count of the annular magnets 4261 may be two. Two of the annular magnetic conducting plates 4264 are disposed on two sides of the two annular magnets 4261 along the axial direction Ax2, and the remaining annular magnetic conducting plate 4264 is disposed between the two annular magnets 4261. Through the above arrangement, the annular magnetic conducting plates 4264 can be configured to better fix the at least the two annular magnets 4261, and also concentrate magnetic induction lines between the two annular magnets 4261 within a magnetic gap, thereby enhancing the magnetic effect in the magnetic gap and improving a sensitivity of the magnetic circuit system 426.

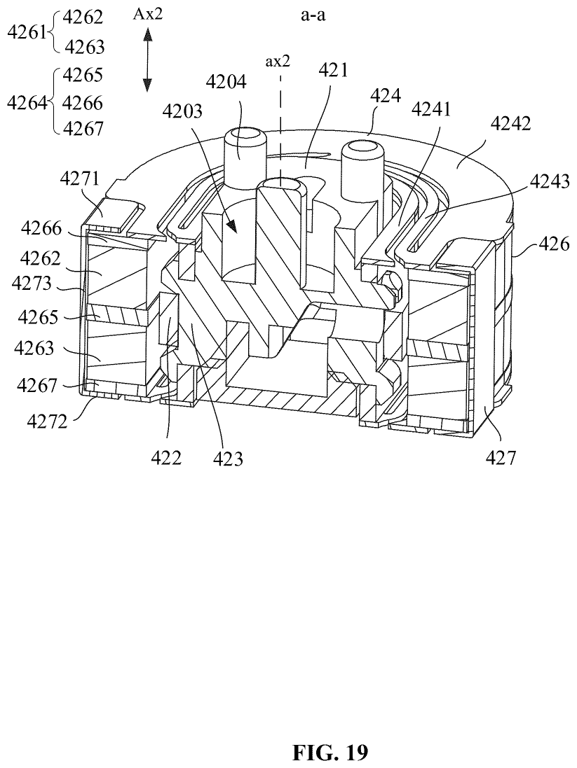

In some embodiments, as shown in FIG. 18 and FIG. 19, the clip 427 may include a first abutting portion 4271, a second abutting portion 4272, and a connecting portion 4273. The first abutting portion 4271 may abut against one outer end surface of the magnetic circuit system 426, the second abutting portion 4272 may abut against another outer end surface of the magnetic circuit system 426, and the connecting portion 4273 may be connected between the first abutting portion 4271 and the second abutting portion 4272.

The first abutting portion 4271 and the second abutting portion 4272 are arranged along the axial direction Ax2 of the transducer 42, and respectively abut against the two outer end surfaces of the magnetic circuit system 426, so as to be fixed to each other along the axial direction Ax2 between the transducer 42 and the magnetic circuit system 426, thereby limiting relative displacement between the at least two annular magnets 4261.

Optionally, the first abutting portion 4271 or the second abutting portion 4272 may abut against an outer end surface of the annular magnetic conducting plate 4264 along the axial direction Ax2 of the transducer 42, so as to fix the at least the two annular magnets 4261 through the annular magnetic conducting plate 4264.

The connecting portion 4273 may be connected between the first abutting portion 4271 and the second abutting portion 4272 to further enhance a restricting function of the clip 427.

With such an arrangement, the clip 427 has a simple structure and is easy to manufacture. The use of the clip 427 can also simplify the structure of the transducer 42. In addition, the transducer 42 can achieve the function of stably fixing the at least the two annular magnets 4261 in the magnetic circuit system 426 by means of the simple clip 427.

For example, in some embodiments, as shown in FIG. 18 and FIG. 19, the first abutting portion 4271, the second abutting portion 4272, and the connecting portion 4273 are integrally formed by bending a plate into a C-shape. Forming the clip 427 by bending the plate facilitates molding of the clip 427 and simplifies a manufacturing process of the transducer 42. Moreover, the E-shaped structure of the clip 427 further simplifies the structure of the clip 427 and facilitates bending and forming of the clip 427. For example, the clip 427 may be formed by stamping.

In some embodiments, the clip 427 may be made of a non-magnetic material. In the transducer 42, a magnetic field of the magnetic circuit system 426 and an electric field of internal components can jointly cause the transducer 42 to vibrate. Therefore, the clip 427 made of the non-magnetic material can reduce interference of the clip 427 with the magnetic field, so that a position of the transducer 42 is more stable and not eccentric, thereby allowing the transducer 42 to operate more stably and ensuring the vibration effect of the transducer 42.

In some embodiments, as shown in FIGS. 18 to 19, a count of the clips 427 may be at least two, and the at least two clips 427 are spaced apart along a circumferential direction of the magnetic circuit system 426. In some embodiments, the at least two clips 427 are evenly spaced apart along the magnetic circuit system 426, so as to limit relative displacement between the at least two annular magnets 4261 while ensuring that a center of gravity of the transducer 42 is located on a vibration axis, thereby ensuring vibration stability of the transducer 42. For example, as shown in the figure, the count of the clips 427 may be two, and the two clips 427 may be arranged opposite to each other along the radial direction of the transducer 42, so as to clamp the magnetic circuit system 426 on both sides of the transducer 42 while ensuring that the center of gravity of the transducer 42 is located on the vibration axis.

The increase of the number of the clips 427 can enhance the fixing effect on the at least two annular magnets 4261 and enable a more uniform stress distribution on the magnetic circuit system 426, thereby improving structural stability and firmness of the transducer 42.

In some embodiments, as shown in FIGS. 17 and 19, the transducer 42 may further include the bracket 421, the coil 422, and a vibration transmitting plate 424. The vibration transmitting plate 424 may be connected to the magnetic circuit system 426 and the bracket 421, so as to elastically suspend the magnetic circuit system 426 at the periphery of the bracket 421. The coil 422 may be disposed on the bracket 421 and located inside the magnetic circuit system 426. The connecting portion 4273 is disposed on an outer side of the magnetic circuit system 426.

The bracket 421 may be disposed inside the at least two annular magnets 4261. The coil 422 may be wound and fixed on the bracket 421 along a radial direction of the bracket 421. The coil 422 corresponds to the at least two annular magnets 4261, such that when the coil 422 is energized, an electric field thereof can interact with magnetic fields of the annular magnets 4261.

Specifically, an electric signal containing relevant audio information may pass through the coil 422 by controlling a current flowing through the coil 422. Since the coil 422 is arranged opposite to the at least two annular magnets 4261 in the radial direction of the transducer 42, the electric field of the coil 422 can interact with the magnetic fields of the at least two annular magnets 4261, so that the magnetic circuit system 426 and the bracket 421 on which the coil 422 is located generate a relative motion.

In the embodiments of the present disclosure, the connecting portion 4273 is disposed on the outer side of the magnetic circuit system 426. In other words, the clip 427 is disposed on an outer side surface of the magnetic circuit system 426 opposite to the bracket 421. With such an arrangement, a gap between the magnetic circuit system 426 and the coil 422 by the bracket 421 can be reduced, thereby making the structure more compact and enhancing the interaction between the magnetic field of the magnetic circuit system 426 and the electric field of the coil 422. Moreover, with the clip 427 disposed in this manner, the clip 427 can be conveniently assembled onto the magnetic circuit system 426, which reduces a manufacturing difficulty of the transducer 42.

Optionally, the count of the vibration transmitting plates 424 may be two, and the two vibration transmitting plates 424 may be sequentially arranged along the axial direction Ax2 of the transducer 42. The two vibration transmitting plates 424 are arranged on two sides of the bracket 421 and the magnetic circuit system 426 along the axial direction Ax2, to connect the bracket 421 and the magnetic circuit system 426 on the two sides. When the magnetic circuit system 426 generates a relative motion in the axial direction Ax2 under the interaction with the coil 422 on the bracket 421, the vibration transmitting plates 424 can drive the bracket 421 to move in the axial direction Ax2. By arranging the two vibration transmitting plates 424 to drive the bracket 421 to move or restore the bracket 421 in the axial direction Ax2, the clastic fixing effect between the bracket 421 and the magnetic circuit system 426 can be enhanced, so that the structure of the transducer 42 becomes more stable.

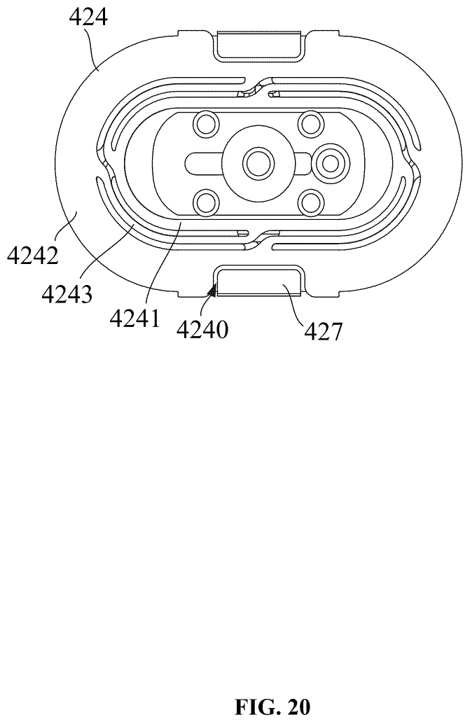

In some embodiments, as shown in FIG. 19 and FIG. 20, each vibration transmitting plate 424 may include an inner ring fixing portion 4241, an outer ring fixing portion 4242, and at least two clastic connecting portions 4243.

The outer ring fixing portion 4242 may be disposed around a periphery of the inner ring fixing portion 4241, and the at least two elastic connecting portions 4243 are connected between the inner ring fixing portion 4241 and the outer ring fixing portion 4242. The inner ring fixing portion 4241 is connected to the bracket 421, and the outer ring fixing portion 4242 is connected to an outer end surface of the magnetic circuit system 426. When the magnetic circuit system 426 vibrates relative to the bracket 421, the magnetic circuit system 426 may drive the outer ring fixing portion 4242 to vibrate. The outer ring fixing portion 4242 is connected to the inner ring fixing portion 4241 through the at least two elastic connecting portions 4243, so that the vibration transmitting plate 424 can elastically constrain the relative motion between the magnetic circuit system 426 and the coil 422. When the transducer 42 vibrates, the vibration transmitting plate 424 can restrict the bracket 421 within the magnetic circuit system 426, such that the operation of the transducer 42 remains stable.

In some embodiments, as shown in FIG. 20, the outer ring fixing portion 4242 may be provided with a notch 4240, an outer end surface of the magnetic circuit system 426 is exposed from the notch 4240, and the first abutting portion 4271 and/or the second abutting portion 4272 is configured to abut against an exposed portion of the outer end surface of the magnetic circuit system 426 from the notch 4240.

The exposed portion of the outer end surface of the magnetic circuit system 426 from the notch 4240 faces the axial direction Ax2 of the transducer 42, so that the first abutting portion 4271 and/or the second abutting portion 4272 can be disposed in the notch 4240 in the axial direction Ax2 of the transducer 42 and abut against the exposed portion of the magnetic circuit system 426.

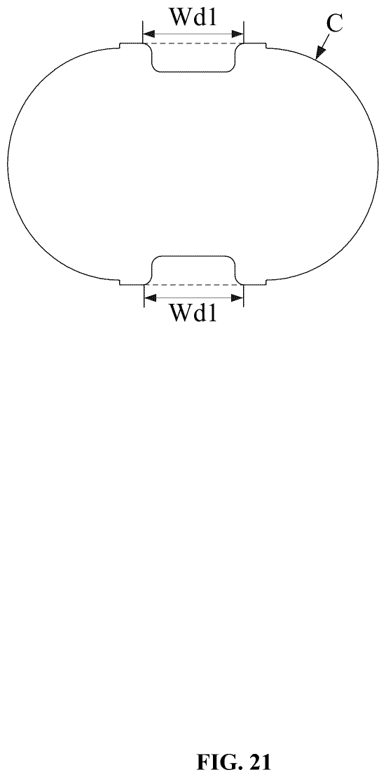

In some embodiments, as shown in FIGS. 20 and 21, a count of the notches 4240 may be at least two, and the notches 4240 are spaced apart along a circumferential direction of the outer ring fixing portion 4242. Each notch 4240 communicates with an outer edge of the outer ring fixing portion 4242. Along the circumferential direction of the outer ring fixing portion 4242, a ratio of a total width Wd1 of the at least two notches 4240 on the outer edge of the outer ring fixing portion 4242 to a circumference C of the outer edge of the outer ring fixing portion 4242 is less than or equal to 0.08 to 0.25.

Optionally, the circumference C of the outer edge of the outer ring fixing portion 4242 may be in a range of 35 mm to 65 mm. The total width Wd1 of the at least two notches 4240 on the outer edge of the outer ring fixing portion 4242 may be in a range of 5 mm to 16 mm. For example, the circumference C of the outer edge of the outer ring fixing portion 4242 may be 40.8 mm, 57.3 mm, or 64.5 mm; the total width Wd1 of the at least two notches 4240 on the outer edge of the outer ring fixing portion 4242 may be 5.6 mm, 10.7 mm, or 15.5 mm; and the ratio of the total width Wd1 of the at least two notches 4240 on the outer edge of the outer ring fixing portion 4242 to the circumference C of the outer edge of the outer ring fixing portion 4242 may be 0.13, 0.18, or 0.24.

Of course, in other embodiments, the ratio of the total width Wd1 of the at least two notches 4240 on the outer edge of the outer ring fixing portion 4242 to the circumference C of the outer edge of the outer ring fixing portion 4242 may be 0.14, 0.17, 0.21, or the like.

If the ratio of the total width Wd1 to the circumference C is too large, the total width Wd1 of the notches would be excessively large, which may affect a structural strength of the vibration transmitting plate 424. Therefore, by setting the above reasonable ratio range, the structural strength of the vibration transmission plate 424 can be ensured, so that the vibration transmission plate 424 is less likely to undergo deformation or fracture during vibration of the transducer 42. Moreover, when the clip 427 abuts against the exposed portion of the magnetic circuit system 426 through the notches 4240, the magnetic circuit system 426 can be more effectively fixed, so that the magnetic circuit system 426 is less likely to become loosened and cause the failure of the conversion function of the transducer 42.

The at least two notches 4240 may correspond to the first abutting portion 4271 and/or the second abutting portion 4272 of the at least two clips 427, and the first abutting portion 4271 and/or the second abutting portion 4272 of the at least two clips 427 may be fixed to portions of the magnetic circuit system 426 exposed from the notches 4240 through the at least two notches 4240.

For example, the number of clips 427 may be two, and the outer ring fixing portion 4242 may be provided with two notches 4240 corresponding to each clip 427. The two notches 4240 may be arranged along the axial direction Ax2 of the transducer 42, one of the notches 4240 corresponds to one outer end surface of the exposed magnetic circuit system 426, and the other notch 4240 corresponds to the other outer end surface of the exposed magnetic circuit system 426. The two exposed portions of the magnetic circuit system 426 may correspond to the first abutting portion 4271 and the second abutting portion 4272, and the first abutting portion 4271 and the second abutting portion 4272 are capable of abutting against the outer end surfaces of the magnetic circuit system 426 that are exposed from the notches 4240.

By structurally cooperating the clip 427 and the vibration transmission plate 424 in such a configuration, the structural compactness of the transducer 42 can be enhanced, and the dimension of the transducer 42 in the axial direction Ax2 can be reduced.

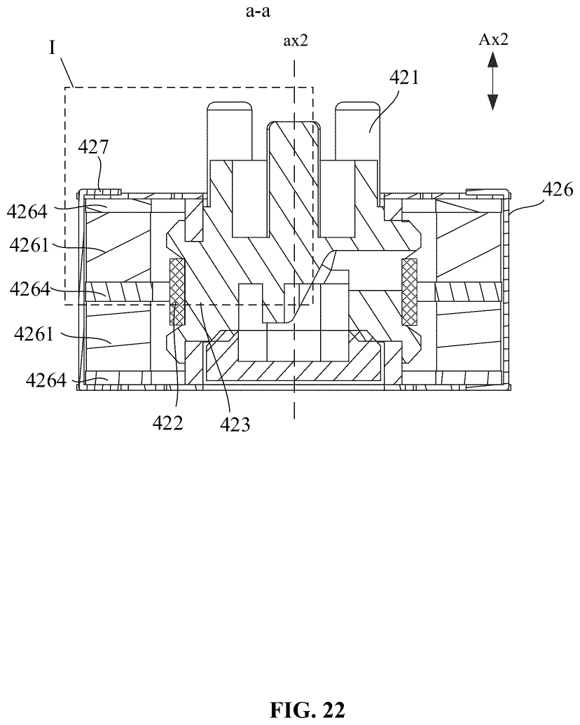

In some embodiments, as shown in FIG. 19 and FIG. 22, the transducer 42 may further include a magnetic conductive cover 423. The magnetic conductive cover 423 is configured in a cylindrical shape and is connected to the bracket 421. The coil 422 may be wound the outer periphery of the magnetic conductive cover 423. The inner ring fixing portion 4241 is connected to an outer end surface of the magnetic conductive cover 423. The vibration transmission plate 424 may be made of a metal material, specifically a magnetically conductive metal member.

The magnetic conductive cover 423 has a certain magnetic conductivity, and the magnetic conductive cover 423 is configured to constrain a magnetic field in the transducer 42. Specifically, the magnetic conductive cover 423 may form a magnetic flux path together with the vibration transmission plate 424 and the magnetic circuit system 426. The coil 422 is wound on an outer side of the magnetic conductive cover 423 so as to be located at a middle position surrounded by the magnetic flux path. When the coil 422 is energized, the electric field of the coil 422 interacts with the magnetic field of the magnetic flux path, thereby enabling the magnetic circuit system 426 and the coil 422 on the bracket 421 to move in the axial direction Ax2, so as to generate vibration of the transducer 42.

In some embodiments, as shown in FIG. 22, the inner ring fixing portion 4241 may be welded and fixed to an outer end surface of the magnetic conductive cover 423, and the outer ring fixing portion 4242 may be welded and fixed to an outer end surface of the magnetic circuit system 426.

Optionally, the outer ring fixing portion 4242 may be welded and fixed to an outer end surface of the annular magnetic guide plate 4264, and the annular magnetic guide plate 4264 may be fixed to the annular magnet 4261, so that the annular magnet 4261 is capable of driving the outer ring fixing portion 4242 to move therewith through the annular magnetic guide plate 4264 during movement.

By welding, the connection among the vibration transmitting plate 424, the magnetic circuit system 426, and the magnetic conductive cover 423 can be enhanced, so as to improve a magnetic flux effect among the vibration transmitting plate 424, the magnetic circuit system 426, and the magnetic conductive cover 423, and also improve the structural stability of the transducer 42.

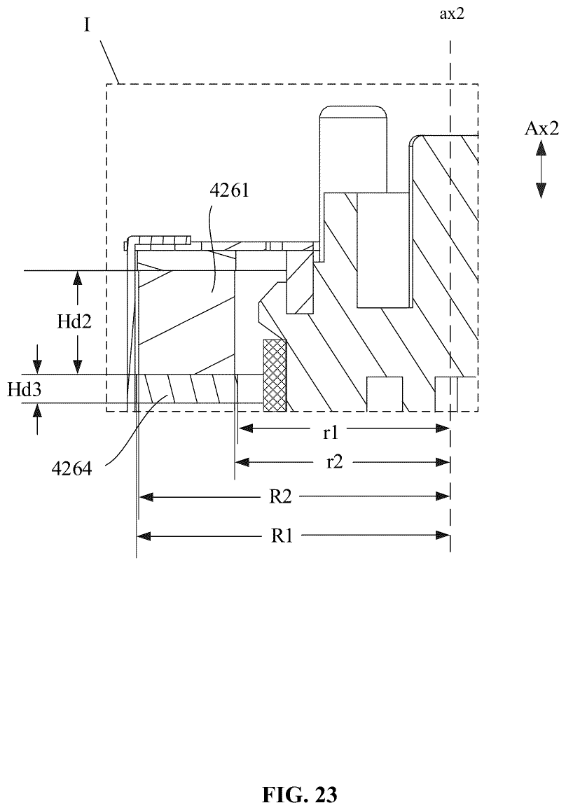

As shown in FIGS. 22 to 23, in some embodiments of the present disclosure, an outer diameter R1 of the annular magnetic guide plate 4264 may be greater than an outer diameter R2 of the annular magnet 4261, and an inner diameter r1 of the annular magnetic guide plate 4264 may be smaller than an inner diameter r2 of the annular magnet 4261.

As shown in FIG. 23, an axis of the magnetic circuit system 426 may be as indicated by the line ax2 in FIG. 23, and an axial direction Ax2 of the magnetic circuit system 426 may be as shown in FIG. 23. The outer diameter R1 of the annular magnetic guide plate 4264 is as indicated by the distance R1 in FIG. 23, and the outer diameter R2 of the annular magnet 4261 is as indicated by the distance R2 in FIG. 23, wherein R1 is greater than R2. The inner diameter r1 of the annular magnetic guide plate 4264 is as indicated by r1 in FIG. 23, and an inner diameter r2 of the annular magnet 4261 is as indicated by r2 in FIG. 23, wherein r1 is less than r2.

With such an arrangement, a radial direction dimension of the annular magnet 4261 is less than a radial direction dimension of the annular magnetic guide plate 4264, and the annular magnet 4261 is arranged at a middle position of the annular magnetic guide plate 4264, so that the annular magnet 4261 is capable of moving with a small range within a portion of the annular magnetic guide plate 4264 that extends beyond the annular magnet 4261 in the radial direction. Moreover, with such an arrangement, a machining accuracy of the annular magnetic guide plate 4264 is higher than a machining accuracy of the annular magnet 4261, so that during installation of the annular magnet 4261, the annular magnetic guide plate 4264 can be used for positioning to facilitate accurate installation and assembly of the annular magnet 4261, thereby improving the positioning accuracy of the annular magnet 4261.

In some embodiments, as shown in FIG. 23, a ratio of a difference between the outer diameter R1 of the annular magnetic guide plate 4264 and the outer diameter R2 of the annular magnet 4261 to a radial width of the annular magnet 4261 is in a range of 0.002 to 0.007. that is, (R1−R2)/(R2−r2)=0.002˜0.007.

The difference between the outer diameter R1 of the annular magnetic guide plate 4264 and the outer diameter R2 of the annular magnet 4261 refers to a distance from an edge of the outer diameter R1 of the annular magnetic guide plate 4264 to the outer diameter R2 of the annular magnet 4261.

In some embodiments, when the ratio described above is too large, the annular magnet 4261 may have a relatively large movement amplitude in the radial direction. As a result, when the magnetic circuit system 426 vibrates, the annular magnet 4261 tends to shift in the radial direction relative to the annular magnetic conducting plate 4264, thereby causing the transducer 42 to become eccentric and adversely affecting vibration performance of the transducer 42. When the ratio is too small, the annular magnet 4261 becomes difficult to position by the annular magnetic conducting plate 4264, thereby increasing assembly difficulty of the transducer 42. Therefore, setting the above ratio within a reasonable range may improve positioning accuracy between the annular magnet 4261 and the annular magnetic conducting plate 4264 and may also reduce the movement amplitude of the annular magnet 4261 in the radial direction, so as to further fix a position of the annular magnet 4261 in the transducer 42.

For example, the ratio between the difference between the outer diameter R1 of the annular magnetic conducting plate 4264 and the outer diameter R2 of the annular magnet 4261 and the radial width of the annular magnet 4261 may be 0.003, 0.005, 0.006, or the like.

In some embodiments, the difference between the outer diameter R1 of the annular magnetic conducting plate 4264 and the outer diameter R2 of the annular magnet 4261 may be in a range of 0.02 mm to 0.08 mm.

For example, the difference between the outer diameter R1 of the annular magnetic conducting plate 4264 and the outer diameter R2 of the annular magnet 4261 may be 0.03 mm, 0.05 mm, 0.07 mm, or the like.

Similarly, when the difference between the outer diameter R1 of the annular magnetic conducting plate 4264 and the outer diameter R2 of the annular magnet 4261 is excessively large, the annular magnet 4261 tends to shift in the radial direction relative to the annular magnetic conducting plate 4264, thereby causing the transducer 42 to become eccentric and adversely affecting vibration performance of the transducer 42. When the difference described above is excessively small, the annular magnet 4261 becomes difficult to be positioned by the annular magnetic conducting plate 4264, thereby increasing assembly difficulty of the transducer 42.

Therefore, by setting the difference between the outer diameter R1 of the annular magnetic conducting plate 4264 and the outer diameter R2 of the annular magnet 4261 within the reasonable range described above, the outer diameter R1 of the annular magnetic conducting plate 4264 may exceed the outer diameter R2 of the annular magnet 4261, so that the machining accuracy of the annular magnetic conducting plate 4264 is higher than the machining accuracy of the annular magnet 4261, thereby improving in the positioning accuracy of the annular magnet 4261. Furthermore, radial dimensions of the annular magnet 4261 and the annular magnetic conducting plate 4264 in the magnetic circuit system 426 may be reduced, so as to further reduce the dimension of the transducer 42.

In some embodiments, a ratio between a difference between the inner diameter r2 of the annular magnet 4261 and the inner diameter r1 of the annular magnetic conducting plate 4264 and the radial width of the annular magnet 4261 may be in a range of 0.003 to 0.009. that is, (r2−r1)/(R2−r2)=0.003˜0.009.

For example, the ratio of the difference between the inner diameter r2 of the annular magnet 4261 and the inner diameter r1 of the annular magnetic conducting plate 4264 to the radial width of the annular magnet 4261 may be 0.004, 0.006, 0.008, or the like.

Specifically, the difference between the inner diameter r2 of the annular magnet 4261 and the inner diameter r1 of the annular magnetic conducting plate 4264 refers to a distance by which an inner edge of the annular magnetic conducting plate 4264 exceeds an inner edge of the annular magnet 4261, namely a difference obtained by subtracting r1 from r2.

When the ratio of the difference between the inner diameter r2 of the annular magnet 4261 and the inner diameter r1 of the annular magnetic conducting plate 4264 to the radial width of the annular magnet 4261 is excessively large, the radial dimension of the annular magnet 4261 becomes excessively small, which may reduce a magnetic field intensity of the annular magnet 4261 and also make the annular magnet 4261 prone to a large displacement in the radial direction. When the ratio of the difference between the inner diameter r2 of the annular magnet 4261 and the inner diameter r1 of the annular magnetic conducting plate 4264 to the radial width of the annular magnet 4261 is excessively small, the annular magnet 4261 becomes difficult to be correspondingly assembled with the annular magnetic conducting plate 4264.

Therefore, by setting the ratio of the difference between the inner diameter r2 of the annular magnet 4261 and the inner diameter r1 of the annular magnetic conducting plate 4264 to the radial width of the annular magnet 4261 within the above reasonable range, the positioning accuracy between the annular magnet 4261 and the annular magnetic conducting plate 4264 may be improved, so as to further fix the position of the annular magnet 4261 in the transducer 42, reduce the amplitude of movement of the annular magnet 4261 in the radial direction, and ensure the magnetic field strength of the annular magnet 4261.

In some embodiments, the difference between an inner diameter r2 of the annular magnet 4261 and the inner diameter r1 of the annular magnetic guide plate 4264 may be in a range of 0.02 mm to 0.08 mm. For example, the difference between the inner diameter r2 of the annular magnet 4261 and the inner diameter r1 of the annular magnetic guide plate 4264 may be 0.03 mm, 0.05 mm, 0.07 mm, or the like.

Similarly, when the difference between the inner diameter r2 of the annular magnet 4261 and the inner diameter r1 of the annular magnetic guide plate 4264 is excessively large, the radial direction dimension of the annular magnet 4261 becomes excessively small, thereby reducing the magnetic field strength of the annular magnet 4261, and the annular magnet 4261 is prone to undergoing large displacement in the radial direction, resulting in unstable vibration of the transducer 42. When the difference between the inner diameter r2 of the annular magnet 4261 and the inner diameter r1 of the annular magnetic guide plate 4264 is excessively small, the annular magnet 4261 is difficult to be assembled with the annular magnetic guide plate 4264.

Therefore, by setting the difference between the inner diameter r2 of the annular magnet 4261 and the inner diameter r1 of the annular magnetic guide plate 4264 within the above reasonable range, the machining accuracy of the annular magnetic guide plate 4264 may be higher than that of the annular magnet 4261, so as to improve the positioning accuracy of the annular magnet 4261 and facilitate assembly of the annular magnet 4261. Moreover, such a configuration may also ensure the magnetic field strength of the annular magnet 4261, make the annular magnet 4261 less prone to large displacement in the radial direction, thereby ensuring the vibration effect of the transducer 42, and reduce the radial direction dimension of the annular magnet 4261 in the magnetic circuit system 426 to reduce the dimension of the transducer 42.

In some embodiments, an axial thickness Hd3 of the annular magnetic guide plate 4264 may be less than an axial thickness Hd2 of the annular magnet 4261. As shown in FIG. 23, the axial thickness Hd3 of the annular magnetic guide plate 4264 may correspond to the thickness Hd3 shown in FIG. 23, and the axial thickness Hd2 of the annular magnet 4261 may correspond to the thickness Hd2 shown in FIG. 23, where Hd3 is less than Hd2.

Since the annular magnet 4261 primarily functions as a component for generating a magnetic field, the axial thickness Hd2 of the annular magnet 4261 has specific requirements to enable the annular magnet 4261 to generate a corresponding vibration signal. In contrast, the annular magnetic guide plate 4264 primarily functions to improve positioning accuracy of the annular magnet 4261 for facilitating positioning and mounting of the annular magnet 4261. Therefore, by setting the axial thickness Hd3 of the annular magnetic guide plate 4264 to be less than the axial thickness Hd2 of the annular magnet 4261, the annular magnetic guide plate 4264 is less likely to interfere with the magnetic field of the annular magnet 4261, thereby further ensuring a vibration effect of the transducer 42.

Moreover, by setting a relatively small axial thickness Hd3 of the annular magnetic guide plate 4264, the overall dimension of the transducer 42 in the axial direction Ax2 may be reduced, and the positioning accuracy of the annular magnet 4261 may also be improved, thereby facilitating positioning and mounting of the annular magnet 4261.

In some embodiments, as shown in FIG. 19, the annular magnet 4261 may include a first annular magnet 4262 and a second annular magnet 4263. The annular magnetic guide plate 4264 may include a first annular magnetic guide plate 4265, a second annular magnetic guide plate 4266, and a third annular magnetic guide plate 4267.

The first annular magnetic guide plate 4265 may be clamped in an axial direction Ax2 between the first annular magnet 4262 and the second annular magnet 4263. The second annular magnetic guide plate 4266 may be disposed on an outer end surface of the first annular magnet 4262 away from the second annular magnet 4263. The third annular magnetic guide plate 4267 may be disposed on an outer end surface of the second annular magnet 4263 away from the first annular magnet 4262.

The first annular magnet 4262 and the second annular magnet 4263 may be two magnets having mutually repulsive polarities. The mutually repulsive polarities of the first annular magnet 4262 and the second annular magnet 4263 may enable magnetic induction lines to concentrate within a magnetic gap between the first annular magnet 4262 and the second annular magnet 4263, thereby enhancing the magnetic field effect within the magnetic gap and improving sensitivity of the magnetic circuit system 426.

Since, after the transducer 42 is energized, the magnetic fields of the first annular magnet 4262 and the second annular magnet 4263 may cause movements of the first annular magnet 4262 and the second annular magnet 4263 under an electric field, the first annular magnetic guide plate 4265, the second annular magnetic guide plate 4266, and the third annular magnetic guide plate 4267 may constrain the magnetic fields of the first annular magnet 4262 and the second annular magnet 4263, so as to concentrate the magnetic fields and increase interaction between the magnetic fields and the electric field, thereby enhancing vibration performance of the transducer 42. Moreover, by arranging the first annular magnet 4262 being located between the second annular magnet 4263 and the first annular magnetic guide plate 4265, the second annular magnet 4263 and the first annular magnetic guide plate 4265 may axially position and fix the first annular magnet 4262 in the axial direction Ax2 with greater accuracy. Similarly, by arranging the second annular magnet 4263 being located between the third annular magnetic guide plate 4267 and the first annular magnetic guide plate 4265, the third annular magnetic guide plate 4267 and the first annular magnetic guide plate 4265 may axially position and fix the second annular magnet 4263 in the axial direction Ax2 with greater accuracy.

In some embodiments, as shown in FIGS. 17 and 19, the coil 422 overlaps with the first annular magnetic guide plate 4265 in the axial direction Ax2.

Specifically, the coil 422 is correspondingly arranged with the annular magnet 4261 in the radial direction of the coil 422. The coil 422 may be energized so that an electric signal carrying audio information passes through the coil 422. The electric field generated by the coil 422 may act on the magnetic field of the annular magnet 4261, thereby causing relative movement between the annular magnet 4261 and the coil 422. Since the annular magnet 4261 is fixed to the annular magnetic guide plate 4264, the annular magnet 4261 may drive the annular magnetic guide plate 4264 to vibrate together.

Optionally, as shown in FIGS. 17 and 19, the outer ring fixing portion 4242 is connected to an outer end surface of the second annular magnetic guide plate 4266 or the third annular magnetic guide plate 4267, and the inner ring fixing portion 4241 is connected to an outer end surface of the magnetic conductive cover 423. The vibration transmission plate 424 is connected to the second annular magnetic guide plate 4266 or the third annular magnetic guide plate 4267 through the outer ring fixing portion 4242, and further connected to the first annular magnet 4262 or the second annular magnet 4263 through the second annular magnetic guide plate 4266 or the third annular magnetic guide plate 4267.

Optionally, the vibration transmission plate 424 may be a magnetic conductor. In this manner, the magnetic field of the transducer 42 may be confined, which facilitates the magnetic field to converge toward the coil 422, thereby enhancing the magnetic field intensity at the coil 422 to improve the vibration effect of the transducer 42. Moreover, the coil 422 may be disposed at a middle position of a magnetic flux path, such that when the coil 422 is energized, the electric field generated by the coil 422 may interact with the magnetic flux path, thereby enabling relative movement between the coil 422 and the magnetic circuit system 426, and enabling the transducer 42 to perform energy conversion between electrical energy and mechanical vibration.

When the magnetic circuit system 426 and the coil 422 stop vibrating, the at least two clastic connecting portions 4243 may also elastically restore the inner ring fixing portion 4241, such that the bracket 421 and the magnetic conductive cover 423 may return to original positions relative to the magnetic circuit system 426.

Optionally, a count of the elastic connecting portions 4243 may be four. The four elastic connecting portions 4243 may allow the force on the vibration transmission plate 424 more uniform, thereby improving structural stability of the vibration transmission plate 424.

In some embodiments, as shown in FIGS. 17 and 19, the clip 427 may be configured to axially clamp outer end surfaces of the second annular magnetic guide plate 4266 and the third annular magnetic guide plate 4267 along the axial direction Ax2.

As shown in FIG. 2, in some embodiments, the speaker assembly 3 may also include the air conduction speaker 50. The air conduction speaker 50 is capable of converting an electrical signal containing relevant audio information into an acoustic signal.

Specifically, the air conduction speaker 50 is configured to provide air conduction sound in a first frequency band, and the bone conduction speaker 40 is configured to provide bone conduction sound in a second frequency band, where the second frequency band is at least partially higher than the first frequency band. In other words, the air conduction speaker 50 is configured to provide sound in a lower frequency band, and the bone conduction speaker 40 is configured to enhance sound in a higher frequency band. With such a configuration, the sound output performance of the speaker assembly 3 may be enhanced, making both low-frequency and high-frequency sounds clearer.

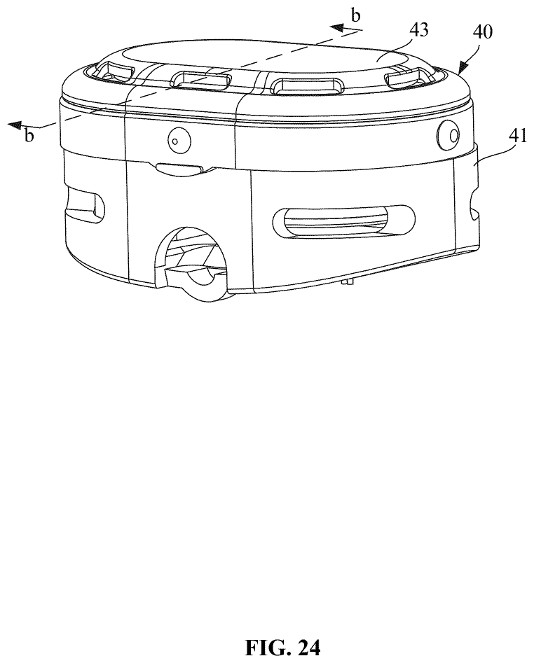

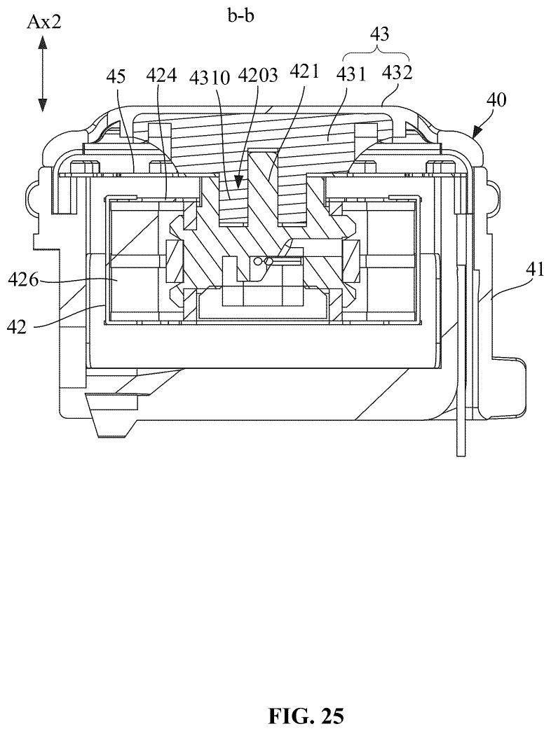

In some embodiments, as shown in FIGS. 24 and 25, the bone conduction speaker 40 may include the core housing 41, the first vibration transmitting plate 45, and the transducer 42. The first vibration transmitting plate 45 connects the core housing 41 and the transducer 42 to suspend the transducer 42 within the core housing 41.

In some embodiments, the transducer 42 serves as a main device in the bone conduction speaker 40 for converting an electric signal into a vibration signal. The transducer 42 may be arranged inside the core housing 41, and the core housing 41 is configured to relatively fix the transducer 42. The first vibration transmitting plate 45 is configured to be constrained to vibrate within the core housing 41 when the transducer 42 vibrates mechanically, such that the transducer 42 is not prone to falling out from the core housing 41.

In some embodiments, as shown in FIG. 25, the transducer 42 may further include the bracket 421, the coil 422, the magnetic circuit system 426, and a second vibration transmitting plate 424. The second vibration transmitting plate 424 is connected to the magnetic circuit system 426 and the bracket 421 to elastically suspend the magnetic circuit system 426 around the periphery of the bracket 421. The coil 422 is disposed on the bracket 421 and is located inside the magnetic circuit system 426.

Optionally, the first vibration transmitting plate 45 may be a non-magnetic conductive body, and the second vibration transmitting plate 424 may be a magnetic conductive body. The first vibration transmitting plate 45 may be made of a non-magnetic metal material such as stainless steel or copper, and may also be made of a non-metal material capable of meeting corresponding requirements. The second vibration transmitting plate 424 may be made of a metal material having magnetic conductivity, such as a material containing metallic elements including iron, cobalt, nickel, or the like.

The first vibration transmitting plate 45 is mainly configured to fix the transducer 42 inside the core housing 41. Therefore, by configuring the first vibration transmitting plate 45 as the non-magnetic conductive body, the first vibration transmitting plate 45 is not prone to being attracted by the magnetic circuit system 426 and causing eccentricity, thereby reducing the impact of the first vibration transmitting plate 45 on the vibration effect of the transducer 42. In addition, due to the clastic function of the first vibration transmitting plate 45, the transducer 42 may be suspended within the core housing 41, such that a portion of the vibration generated by the transducer 42 that is transmitted to the core housing 41 is reduced, thereby reducing the vibration generated by the core housing 41 and further reducing sound leakage.

Based on the above configuration, the first vibration transmitting plate 45 is configured as the non-magnetic conductive body, such that the position of the transducer 42 remains relatively stable without eccentricity, thereby allowing the transducer 42 to operate more stably and generate more stable vibrations. Furthermore, the second vibration transmitting plate 424 is configured as the magnetic conductive body, such that the second vibration transmitting plate 424 may constrain the magnetic field within the transducer 42 and facilitate the concentration of the magnetic field toward the coil 422, thereby enhancing the magnetic field strength at the coil 422 and improving the vibration performance of the transducer 42.

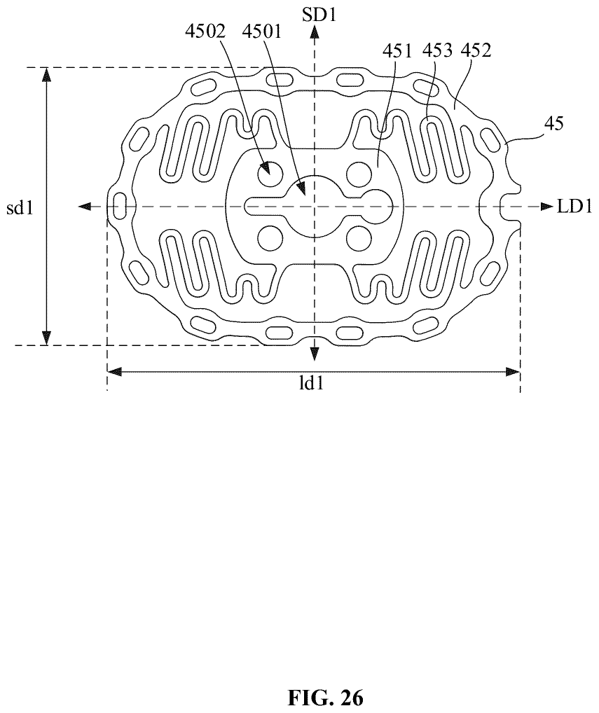

In some embodiments, as shown in FIG. 26, the first vibration transmitting plate 45 may have the long axis direction LD1 and the short axis direction SD1 perpendicular to each other. A dimension of the first vibration transmitting plate 45 in the long axis direction LD1 may be greater than a dimension in the short axis direction SD1. The clastic coefficient of the first vibration transmitting plate 45 in the long axis direction LD1 may be greater than 15000 N/m, and/or the clastic coefficient in the short axis direction SD1 may be greater than 6500 N/m.

Optionally, the elastic coefficient of the first vibration transmitting plate 45 may be calculated utilizing Hooke's Law of material. For example, when the elastic coefficient of the first vibration transmitting plate 45 in the long axis direction LD1 is measured, one end of the first vibration transmitting plate 45 in the long axis direction LD1 may be fixed, and a weight may be suspended on the other end in the long axis direction LD1. After the deformation of the first vibration transmitting plate 45 in the long axis direction LD1 becomes stable, a displacement of the end that the weight is suspended on may be measured. Then, the clastic coefficient in the long axis direction LD1 may be obtained based on the mass of the weight and the displacement of the end where the weight is suspended. The elastic coefficient of the first vibration transmitting plate 45 in the short axis direction SD2 may also be measured and calculated in a similar manner.

The long axis direction LD1 of the first vibration transmitting plate 45 may be indicated by the arrow LD1 shown in FIG. 26, and the dimension of the first vibration transmitting plate 45 in the long axis direction LD1 may be indicated by the length ld1. The short axis direction SD1 of the first vibration transmitting plate 45 may be indicated by the direction SD1 shown in FIG. 26, and the dimension of the first vibration transmitting plate along the short axis direction may be indicated by the length sd1.

When the clastic coefficients of the first vibration transmitting plate 45 along the long axis direction LD1 and the short axis direction SD1 are excessively small, the first vibration transmitting plate 45 is prone to deformation along the long axis direction LD1 and the short axis direction SD1, resulting in deflection of the position of the transducer 42 and instability of vibration, which further leads to undesired noise generated by the bone conduction speaker 40. By setting the elastic coefficient of the first vibration transmitting plate 45 along the long axis direction LD1 and/or the elastic coefficient of the first vibration transmitting plate 45 along the short axis direction SD1 within the above range, the first vibration transmitting plate 45 may have relatively high rigidity along the long axis direction LD1 and/or the short axis direction SD1, such that the first vibration transmitting plate 45 is less likely to deform in the corresponding direction. Accordingly, a situation in which the first vibration transmitting plate 45 undergoes lateral deformation under vibration of the transducer 42 may be reduced, generation of abnormal sounds of the speaker assembly 3 due to vibration of the first vibration transmitting plate 45 may also be reduced, and a situation in which the transducer 42 is deflected in position may also be reduced, thereby ensuring the vibration effect of the bone conduction speaker 40 and improving the structural stability of the bone conduction speaker 40.

For example, the elastic coefficient of the first vibration transmitting plate 45 along the long axis direction LD1 may be 20000 N/m, 25000 N/m, or 30000 N/m. Optionally, the clastic coefficient of the first vibration transmitting plate 45 along the short axis direction SD1 may be 6500 N/m, 7000 N/m, or 8000 N/m.

In some embodiments, as shown in FIG. 26, the first vibration transmitting plate 45 may include a first inner ring fixing portion 451, a first outer ring fixing portion 452, and at least two first clastic connecting portions 453. The first outer ring fixing portion 452 may be arranged around a periphery of the first inner ring fixing portion 451. The at least two first clastic connecting portions 453 are connected between the first inner ring fixing portion 451 and the first outer ring fixing portion 452. The first outer ring fixing portion 452 is assembled and fixed to the core housing 41 in a plug-in manner, and the first inner ring fixing portion 451 is assembled and fixed to the bracket 421 in a plug-in manner.

When the transducer 42 generates mechanical vibration relative to the core housing 41, the bracket 421 drives the first inner ring fixing portion 451 to vibrate. When the first inner ring fixing portion 451 vibrates, the first inner ring fixing portion 451 drives the at least two first clastic connecting portions 453 to undergo elastic deformation. The at least two first clastic connecting portions 453 are capable of constraining the transducer 42 within the core housing 41. When the transducer 42 stops vibrating, the at least two first elastic connecting portions 453 may restore the first inner ring fixing portion 451 and thereby return the transducer 42 to the original position.

Furthermore, by assembling and fixing the first outer ring fixing portion 452 to the core housing 41 and the first inner ring fixing portion 451 to the bracket 421 in the plug-in manner, installation of the first vibration transmitting plate 45 may be facilitated, such that assembly of the speaker assembly 3 may be simplified, thereby improving assembly efficiency and reducing assembly difficulty of the speaker assembly 3.

For example, in some embodiments, a count of the first elastic connecting portions 453 may be four. The four first clastic connecting portions 453 may be evenly arranged between the first outer ring fixing portion 452 and the first inner ring fixing portion 451. When the first inner ring fixing portion 451 is driven to displace, the four first elastic connecting portions 453 may elastically deform together to constrain the first inner ring fixing portion 451, so that the first inner ring fixing portion 451 and the first outer ring fixing portion 452 are subjected to a more balanced force, thereby improving structural stability of the first vibration transmitting plate 45.

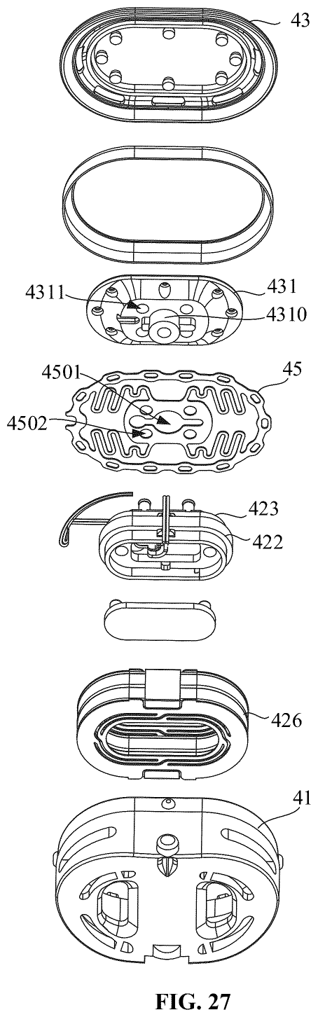

In some embodiments, as shown in FIGS. 25 to 27, the bone conduction speaker 40 may further include the vibration plate 431. The first socket hole 4203 and the plurality of first plug posts 4204 may be provided on a side of the bracket 421 facing the first inner ring fixing portion 451, and the plurality of first plug posts 4204 may be arranged around and spaced apart on the periphery of the first socket hole 4203. The first inner ring fixing portion 451 may be provided with the exposed hole 4501 and the plurality of assembly holes 4502, and the plurality of assembly holes 4502 may be arranged around and spaced apart on the periphery of the exposed hole 4501. The first socket hole 4203 is exposed through the exposed hole 4501, and the first plug posts 4204 are inserted into corresponding assembly holes 4502.

The second plug post 4310 and the plurality of second socket holes 4311 may be provided on the vibration plate 431, the plurality of second socket holes 4311 are arranged around and spaced apart on the periphery of the second plug post 4310, the second plug post 4310 is plug-fitted with the first socket hole 4203, and the first plug posts 4204 are plug-fitted with the second socket holes 4311.

The vibration plate 431 and the bracket 421 may further fix the first inner ring fixing portion 451 between the vibration plate 431 and the bracket 421 by means of plug fitting, so as to improve assembly efficiency, so that the first vibration transmitting plate 45 may be strongly connected to the transducer 42, thereby further improving structural stability of the bone conduction speaker 40.

In some embodiments, when mechanical vibration occurs in the transducer 42, the transducer 42 may drive the vibration plate 431 to vibrate, so as to transmit a vibration signal to a human body through the vibration plate 431.

In some embodiments, as shown in FIGS. 17 to 19, the second vibration transmitting plate 424 may include a second inner ring fixing portion 4241, a second outer ring fixing portion 4242, and at least two second elastic connecting portions 4243. The second outer ring fixing portion 4242 is disposed around a periphery of the second inner ring fixing portion 4241, and the at least two second elastic connecting portions 4243 are connected between the second inner ring fixing portion 4241 and the second outer ring fixing portion 4242. The second outer ring fixing portion 4242 is connected to an outer end surface of the magnetic circuit system 426, and the second inner ring fixing portion 4241 is connected to an outer end surface of the magnetic conductive cover 423.

In some embodiments, as shown in FIG. 19, the second inner ring fixing portion 4241 may be fixedly welded to the outer end surface of the magnetic conductive cover 423, and the second outer ring fixing portion 4242 may be fixedly welded to the outer end surface of the magnetic circuit system 426. By adopting the welding manner, the second vibration transmitting plate 424 may be conveniently mounted on the outer end surfaces of the magnetic circuit system 426 and the magnetic conductive cover 423, thereby simplifying an assembly process of the transducer 42. Moreover, the welding connection manner may enhance connection strength of the second vibration transmitting plate 424 with the magnetic circuit system 426 and the magnetic conductive cover 423, so that the structure of the transducer 42 becomes firmer and more stable.

In some embodiments, a coverage degree of the second outer ring fixing portion 4242 on the outer end surface of the magnetic circuit system 426 may be greater than or equal to 60%, and/or a coverage degree of the second inner ring fixing portion 4241 on the outer end surface of the magnetic conductive cover 423 may be greater than or equal to 60%.

The outer end surface of the magnetic circuit system 426 refers to an end surface of the magnetic circuit system 426 facing the axial direction Ax2, and the outer end surface of the magnetic circuit system 426 may be perpendicular to the axial direction Ax2 of the transducer 42.

Specifically, the coverage degree of the second outer ring fixing portion 4242 on the outer end surface of the magnetic circuit system 426 may refer to an overlap region between the second outer ring fixing portion 4242 and the outer end surface of the magnetic circuit system 426 along the axial direction Ax2 of the transducer 42. The coverage degree of the second inner ring fixing portion 4241 on the outer end surface of the magnetic conductive cover 423 may also be an overlap region of the outer end surface of the second inner ring fixing portion 4241 and the magnetic conductive cover 423 in the axial direction Ax2 of the transducer device 42.

For example, the coverage degree of the second outer ring fixing portion 4242 on the outer end surface of the magnetic circuit system 426 may be 70%, 80%, 90%, or the like. Optionally, the coverage degree of the second inner ring fixing portion 4241 on the outer end surface of the magnetic conductive cover 423 may be 70%, 80%, 90%, or the like.

When the coverage degree of the second outer ring fixing portion 4242 on the outer end surface of the magnetic circuit system 426 is too small, the fixation between the second outer ring fixing portion 4242 and the magnetic circuit system 426 becomes unstable, the magnetic conduction effect of the second vibration transmitting plate 424 is reduced, and the enhancing effect on a magnetic field intensity of a magnetic gap is further weakened. Therefore, by setting the coverage degree of the second outer ring fixing portion 4242 on the outer end surface of the magnetic circuit system 426 to the above values, the fixation between the second outer ring fixing portion 4242 and the magnetic circuit system 426 may be ensured, and the magnetic conduction function of the second vibration transmitting plate 424 may also be enhanced, thereby enhancing the magnetic field intensity of the magnetic gap.

When the coverage degree of the second inner ring fixing portion 4241 on the outer end surface of the magnetic conductive cover 423 is too small, the fixation between the second inner ring fixing portion 4241 and the outer end surface of the magnetic conductive cover 423 becomes poor, and a magnetic field confinement effect of the second vibration transmitting plate 424 is reduced. Therefore, by setting the coverage degree of the second outer ring fixing portion 4242 on the outer end surface of the magnetic circuit system 426 to the above values, the connection between the second vibration transmitting plate 424 and the magnetic circuit system 426 as well as the magnetic conductive cover 423 may be enhanced, so that separation of the second vibration transmitting plate 424 from the magnetic circuit system 426 and the magnetic conductive cover 423 is less likely to occur during movement, thereby improving structural stability of the bone conduction speaker 40 and enhancing the magnetic field confinement effect.

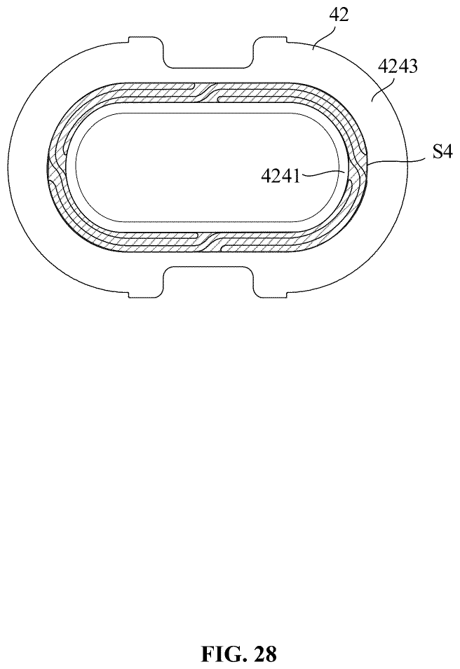

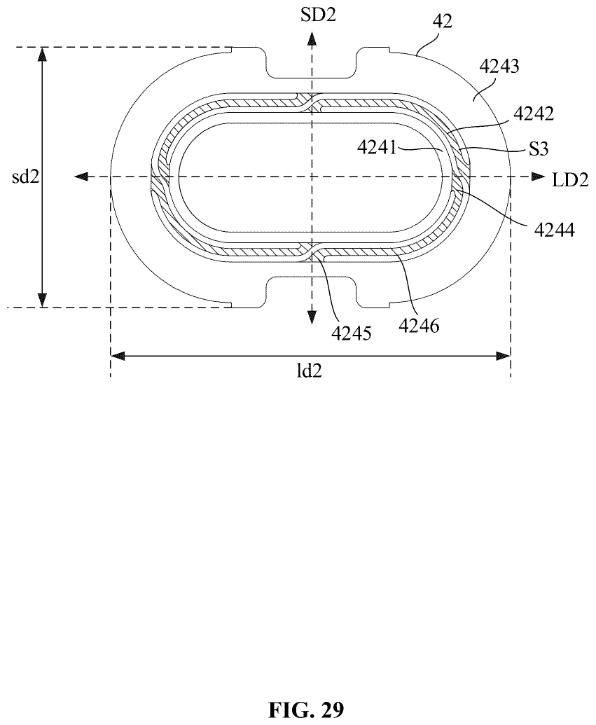

In some embodiments, as shown FIGS. 28 and 29, when viewed along the vibration direction of the transducer 42, the at least two second elastic connecting portions 4243 may have a first area S3, and an annular region between an outer edge of the second inner ring fixing portion 4241 and an inner edge of the second outer ring fixing portion 4242 may have a second arca S4. A ratio of the first area S3 to the second area S4 may be in a range of 0.2 to 0.7.

The first area S3 may correspond to a shaded region shown in FIG. 29, and the second arca S4 may correspond to a shaded region shown in FIG. 28.

Specifically, the at least two second elastic connecting portions 4243 are arranged in the annular region between the outer edge of the second inner ring fixing portion 4241 and the inner edge of the second outer ring fixing portion 4242. The ratio of the first area S3 to the second area S4 may also represent a ratio of an area of the at least two second elastic connecting portions 4243 to an arca of the annular region.

When the first area S3 is too large such that the ratio of the first area S3 to the second area S4 becomes too high, the elasticity of the at least two second elastic connecting portions 4243 may be reduced, thereby affecting the vibration effect of the transducer 42. When the first arca S3 is too small such that the ratio of the first area S3 to the second area S4 becomes too low, the magnetic field convergence effect of the at least two second clastic connecting portions 4243 may be impaired, resulting in a decreased magnetic field confinement effect of the second vibration transmitting plate 424.

Therefore, by setting the ratio of the area of the at least two second elastic connecting portions 4243 to the area of the annular region in the range of 0.2 to 0.7, the at least two second clastic connecting portions 4243 may achieve a certain magnetic field convergence effect to confine and converge the magnetic field. Meanwhile, by limiting the area of the at least two second elastic connecting portions 4243, the elasticity of the at least two second clastic connecting portions 4243 may also be constrained, so that the at least two second elastic connecting portions 4243 do not adversely affect the vibration effect of the transducer 42 due to excessive elasticity.

For example, the first area S3 of the at least two second elastic connecting portions 4243 may be 12.5, 14, or 15.5 square millimeters, the second area S4 of the annular region between the outer edge of the second inner ring fixing portion 4241 and the inner edge of the second outer ring fixing portion 4242 may be 33.5, 35, or 36.5 square millimeters, and the ratio of the first arca S3 to the second area S4 may be 0.4.

Of course, in other embodiments, the ratio of the first area S3 to the second area S4 may also be 0.3, 0.5, 0.6, or other values.

In some embodiments, as shown in FIG. 29, each of the second elastic connecting portions 4243 may include a first connecting portion 4244, a second connecting portion 4245, and an elastic portion 4246. The first connecting portion 4244 may be connected to the outer edge of the second inner ring fixing portion 4241, the second connecting portion 4245 may be connected to the inner edge of the second outer ring fixing portion 4242, and the clastic portion 4246 is located between the first connecting portion 4244 and the second connecting portion 4245. The clastic portion 4246 may be spaced apart from the outer edge of the second inner ring fixing portion 4241 and the inner edge of the second outer ring fixing portion 4242 respectively, with spacing distances in a range of 0.1 mm to 0.4 mm. For example, the spacing distances may be 0.17 mm, 0.26 mm, 0.29 mm, or 0.35 mm. In a plane perpendicular to the axial direction Ax2, a width of the elastic portion 4246 may be 0.28 mm, 0.34 mm, 0.41 mm, or other values.

Specifically, during an elastic movement of the second outer elastic connecting portion 4243, an clastic deformation primarily occurs in the elastic portion 4246. The spacing distance between the clastic portion 4246 and the outer edge of the second inner ring fixing portion 4241 and the spacing distance between the elastic portion 4246 and the inner edge of the second outer ring fixing portion 4242 affect a size of the clastic portion 4246. Therefore, by setting the spacing distances in a range of 0.1 mm to 0.4 mm, the elastic portion 4246 may have a relatively large volume, thereby effectively converging the magnetic field, and may also be less likely to come into contact with the second inner ring fixing portion 4241 and the second outer ring fixing portion 4242. Particularly, when the elastic portion 4246 undergoes clastic deformation and drives the second inner ring fixing portion 4241 to vibrate, interference between the clastic portion 4246 and the second inner ring fixing portion 4241 or the second outer ring fixing portion 4242 is unlikely to occur, thereby ensuring the vibration effect of the transducer 42.

In some embodiments, as shown FIG. 29, the second vibration transmitting plate 424 may have a long axis direction LD2 and a short axis direction SD2, a dimension of the second vibration transmitting plate 424 along the long axis direction LD2 is greater than a dimension of the second vibration transmitting plate 424 along the short axis direction SD2, an clastic coefficient of the second vibration transmitting plate 424 along the long axis direction LD2 is greater than or equal to 55000 N/m, and/or an elastic coefficient along the short axis direction SD2 is greater than or equal to 9500 N/m.

The long axis direction LD2 of the second vibration transmitting plate 424 may correspond to a direction indicated by an arrow labeled LD2 in FIG. 29, and the dimension of the second vibration transmitting plate 424 along the long axis direction LD2 may be as shown by a length ld2. The short axis direction SD2 of the second vibration transmitting plate 424 may correspond to a direction indicated by an arrow labeled SD2 in FIG. 29, and the dimension of the second vibration transmitting plate 424 along the short axis direction SD2 may be as shown by a length sd2.

Specifically, when clastic coefficients of the second vibration transmitting plate 424 along the long axis direction LD2 and the short axis direction SD2 are too small, the second vibration transmitting plate 424 is prone to deformation during vibration of the transducer 42, which may result in positional deviation and unstable vibration of the transducer 42, and further cause abnormal noise in the bone conduction speaker 40.

Therefore, by setting the elastic coefficient of the second vibration transmitting plate 424 along the long axis direction LD2 to be greater than or equal to 55000 N/m, and setting the clastic coefficient along the short axis direction SD2 to be greater than or equal to 9500 N/m, the second vibration transmitting plate 424 may have a certain degree of rigidity, so as to space the magnetic conductive cover 423 apart from the magnetic circuit system 426 and prevent the magnetic conductive cover 423 from being attracted to the magnetic circuit system 426 as much as possible. Meanwhile, by setting the clastic coefficients of the second vibration transmitting plate 424 in the long axis direction LD2 and the short axis direction SD2 to relatively high values, the clastic portion 4246 of the second vibration transmitting plate 424 may be prevented from breakage or deformation under high vibration intensity, thereby improving reliability and structural stability of the second vibration transmitting plate 424 and ensuring the vibration effect of the transducer 42.

For example, the clastic coefficient of the second vibration transmitting plate 424 along the long axis direction LD2 may be 60000 N/m, 70000 N/m, 80000 N/m, or the like. Alternatively, the clastic coefficient of the second vibration transmitting plate 424 along the short axis direction SD2 may be 10000 N/m, 20000 N/m, 25000 N/m, or the like.

In some embodiments, as shown FIGS. 2 and 25, the bone conduction speaker 40 may further include the vibration transmitting face-attaching assembly 43 and the auxiliary face-attaching assembly 44.

The vibration transmitting face-attaching assembly 43 may include the vibration plate 431 and the soft vibration transmission component 432. The vibration plate 431 is connected to the transducer 42, and the soft vibration transmission component 432 may be disposed on the vibration plate 431. When the transducer 42 vibrates, the bracket 421 in the transducer 42 may further drive the vibration plate 431 to vibrate, and the vibration plate 431 may further drive the soft vibration transmission component 432 to vibrate so as to generate the vibration signal.

Furthermore, the auxiliary face-attaching assembly 44 may also include a hard support component 441 and a soft contact component 442. The hard support component 441 is connected to the core housing 41, and the soft contact component 442 is disposed on the hard support component 441. The soft contact component 442 and the soft vibration transmission component 432 are configured to contact the facial region on the front side of the tragus of the user in the wearing state. Optionally, the hard support component 441 may be connected to the core housing 41, and the soft contact component 442 may be disposed on a surface of the hard support component 441 away from the core housing 41.

The hard support component 441 and the soft contact component 442 may define a region in which the soft vibration transmission component 432 is exposed, so that the soft vibration transmission component 432 is able to contact the facial region on the front side of the tragus of the user in the wearing state and transmit the vibration signal to the human body.

By arranging the soft contact component 442 and the soft vibration transmission component 432 to simultaneously contact the facial region on the front side of the tragus, the contact area between the speaker assembly 3 and the face of the user may be increased, thereby improving the wearing comfort of the speaker assembly 3.

Optionally, in a natural state, a protrusion height Ht2 of the soft contact component 442 relative to the soft vibration transmission component 432 may be in a range of 0.4 mm to 1 mm. For example, the protrusion height Ht2 of the soft contact component 442 relative to the soft vibration transmission component 432 may be 0.5 mm, 0.6 mm, or 0.8 mm.

Optionally, the softness of the soft contact component 442 may be greater than that of the soft vibration transmission component 432, so that when the speaker assembly 3 is in the wearing state, the soft contact component 442 may improve the wearing comfort of the speaker assembly 3 and may be compressed to become flush with the soft vibration transmission component 432 for joint contact with the face of the human body, thereby distributing pressure applied to the soft vibration transmission component 432 and further improving the vibration effect of the soft vibration transmission component 432.

The above descriptions are merely embodiments of the present disclosure and are not intended to limit the scope of the present disclosure. Any equivalent structural or procedural modifications made based on the contents of the present disclosure and the accompanying drawings, or any direct or indirect applications in other related technical fields, shall fall within the scope of patent protection of the present disclosure.

What is claimed is:

1. A speaker assembly, comprising includes a transducer and a vibration plate, the transducer includes a magnetic conductive cover, a coil, and a bracket, the magnetic conductive cover is configured in a cylindrical shape and is provided with connecting holes connecting an inner wall surface and an outer wall surface of the magnetic conductive cover along a radial direction of the magnetic conductive cover, the bracket is arranged on the magnetic conductive cover in molded manner and includes a bracket body, a limiting portion and a connecting portion, at least a part of the bracket body is arranged inside the inner wall surface, the limiting portion is arranged on the outer wall surface, the connecting portion integrally connects the bracket body and the limiting portion through the connecting holes, the limiting portion is configured to limit the coil arranged on the outer wall surface, and the bracket body is connected to the vibration plate.

2. The speaker assembly according to claim 1, wherein the limiting portion abuts against the coil along an axial direction of the magnetic conductive cover.

3. The speaker assembly according to claim 2, wherein the limiting portion is configured to abut against one side of the coil along the axial direction of the magnetic conductive cover.

4. The speaker assembly according to claim 1, wherein the limiting portion is arranged in a ring shape along a circumferential direction of the magnetic conductive cover.

5. The speaker assembly according to claim 1, wherein the limiting portion includes a first sub-limiting portion and a second sub-limiting portion spaced apart along an axial direction of the magnetic conductive cover, and the coil is wound between the first sub-limiting portion and the second sub-limiting portion.

6. The speaker assembly according to claim 1, wherein a material density of the bracket is less than a material density of the magnetic conductive cover.

7. The speaker assembly according to claim 1, wherein the speaker assembly further includes a lead wire, a weight reduction chamber is arranged on the bracket body, a bracket lead hole is arranged on the connecting portion, a lead end of the coil further extend into the weight reduction chamber through the bracket lead hole, and the lead wire is connected to the lead end of the coil in the weight reduction chamber.

8. The speaker assembly according to claim 7, wherein the lead wire includes two groups of wires, the lead end includes two groups of ends, the two groups of wires connect to the two groups of ends at two connection locations, respectively, the bracket body is provided with a spacing mechanism disposed in the weight reduction chamber, and the spacing mechanism is configured to make the two connection locations maintain a predetermined interval.

9. The speaker assembly according to claim 7, wherein the speaker assembly includes a core housing, a first vibration transmitting plate, and a lead wire, the first vibration transmitting plate includes an inner ring fixing portion, an outer ring fixing portion, and at least two elastic connecting portions, the outer ring fixing portion is disposed around a periphery of the inner ring fixing portion, the at least two elastic connecting portions are connected between the inner ring fixing portion and the outer ring fixing portion, the inner ring fixing portion is connected to the bracket body, and the outer ring fixing portion is connected to the core housing.

10. The speaker assembly according to claim 9, wherein the lead wire is connected to the transducer and includes a first lead portion extending from the inner ring fixing portion to the outer ring fixing portion, when viewed along a vibration direction of the vibration plate, the first vibration transmitting plate has a long axis direction and a short axis direction that are perpendicular to each other, a dimension of the first vibration transmitting plate along the long axis direction is larger than a dimension of the first vibration transmitting plate along the short axis direction, and an angle between the first lead portion and the long axis direction is less than an angle between the first lead portion and the short axis direction.

11. The speaker assembly according to claim 10, wherein the first lead portion is arranged along the long axis direction.

12. The speaker assembly according to claim 9, wherein at least part of the bracket body passes through the inner ring fixing portion and is plug-fitted with the vibration plate.

13. The speaker assembly according to claim 12, wherein the bracket body is provided with a plurality of first plug posts on a side of the bracket body facing the inner ring fixing portion, the inner ring fixing portion is provided with a plurality of assembly holes, a first plug post of the plurality of first plug posts is inserted into a corresponding assembly hole of the plurality of assembly holes, the vibration plate is provided with a plurality of second socket holes, and the plurality of first plug posts are plug-fitted with the plurality of second socket holes.

14. The speaker assembly according to claim 13, wherein at least part of the vibration plate passes through the inner ring fixing portion and is plug-fitted with the bracket body.

15. The speaker assembly according to claim 15, wherein the bracket body is further provided with a first socket hole on a side of the bracket body facing the inner ring fixing portion, the plurality of first plug posts are arranged around and spaced apart on a periphery of the first socket hole, the inner ring fixing portion is further provided with an exposed hole, the plurality of assembly holes are arranged around and spaced apart on a periphery of the exposed hole, the first socket hole is exposed through the exposed hole, the vibration plate is further provided with a second plug post, the plurality of second socket holes are arranged around and spaced apart on a periphery of the second plug post, and the second plug post passes through the exposed hole and is plug-fitted with the first socket hole.

16. The speaker assembly according to claim 15, wherein the bracket body is further provided with a third plug post located in the first socket hole, the vibration plate is provided with a third socket hole located on the second plug post, and the third plug post is plug-fitted with the third socket hole.

17. The speaker assembly according to claim 9, wherein the first vibration transmitting plate is connected to the bracket and the core housing to suspend the transducer in the core housing.

18. The speaker assembly according to claim 9, wherein speaker assembly further includes a cover, and the cover is configured to cover the open end of the weight reduction chamber.

19. The speaker assembly according to claim 18, wherein the core housing includes a bottom wall and a peripheral wall connected to the bottom wall to form an accommodation space with an opening at one end, the transducer is arranged in the accommodation space, and the open end of the weight reduction chamber is arranged toward the bottom wall.

20. A headphone, comprising a speaker assembly and a wearing assembly connected to the speaker assembly, wherein the wearing assembly is configured to position the speaker assembly at a facial area on a front side of a tragus of a user in a wearing state,
the speaker assembly includes a transducer and a vibration plate, the transducer includes a magnetic conductive cover, a coil, and a bracket, the magnetic conductive cover is configured in a cylindrical shape and is provided with connecting holes connecting an inner wall surface and an outer wall surface of the magnetic conductive cover along a radial direction of the magnetic conductive cover, the bracket is arranged on the magnetic conductive cover in molded manner and includes a bracket body, a limiting portion and a connecting portion, at least a part of the bracket body is arranged inside the inner wall surface, the limiting portion is arranged on the outer wall surface, the connecting portion integrally connects the bracket body and the limiting portion through the connecting holes, the limiting portion is configured to limit the coil arranged on the outer wall surface, and the bracket body is connected to the vibration plate.
